(19) United States
(12) Patent Application Publication
(10) Pub. No.: US 2020/0363659 A1
(43) Pub. Date: Nov. 19, 2020

(54) MULTILAYER PHOTOCHROMIC LAMINATE

(71) Applicant: Younger Mfg. Co. dba Younger Optics, Torrance, CA (US)

(72) Inventors: DAVID MARK AMBLER, Rancho Palos Verdes, CA (US); MICHAEL DAVID PEARSON, JR., Cerritos, CA (US); TINA HO, Diamond Bar, CA (US)

(21) Appl. No.: 16/414,562

(22) Filed: May 16, 2019

(51) Int. Cl. G02C 7/10

(52) U.S. Cl. CPC G02C 7/102; G02C 2202/16

(57) ABSTRACT

A photochromic multilayer laminate with excellent darkening and fade-back speed and an eyewear lens incorporating the laminate are described. The laminate comprises at least three layers of polyvinyl alcohol, in which the third layer, comprising polyvinyl alcohol and one or more photochromic materials, is positioned between the surfaces of the two other polyvinyl alcohol layers. In one embodiment, the laminate is free of polarizer components and polarizing coatings. In other embodiments, the photochromic materials in the third layer have a form selected from the group including nanodroplets, photochromic nanoparticles and encapsulated forms with a capsule size between about 20 and 500 nm. The laminate and the eyewear lens may have additional layers, elements and additives.

### BACKGROUND

### Field

This disclosure relates generally to eyewear and more specifically to eyewear lenses with photochromic response.

### Description of the Related Art

Eyewear is commonly used to correct vision errors, aberrations and focusing deficiencies caused by genetics, age, disease or other factors. In addition to correcting physiological vision problems, eyewear may also be used to ameliorate physical or environmental conditions (such as glare, variable lighting, high intensity light, dust, condensation, etc.) that can affect sight.

Variable lighting conditions can interfere with proper vision and acuity. When subjected to sudden or drastic changes in illumination, the eye requires a measurable amount of time to adjust to both lighter or darker conditions, and it is common (albeit extremely uncomfortable and potentially dangerous) to have a feeling of momentary blindness during these transitional periods.

Most people are familiar with the benefit of sunglasses in moderating such discomfort in bright daylight conditions. Static tinted lenses cut down on the intensity of light, and certain colors of lenses may be chosen for aesthetic reasons, or to preferentially block or absorb specific wavelength regions to further assist with depth perception or contrast enhancement. Polarized sunglasses are particularly effective at blocking blinding glare and easing eyestrain. Photochromic lenses, which respond to changes in light intensity, are another approach to improve eye comfort in bright light conditions.

The organic photochromic agents in common use for photochromic eyeglass lenses have labile structures that change their molecular orientation by bond breaking, electron transfer and/or rotation in response to absorption of radiant energy, and exhibit visible color in at least one of their molecular configurations. These re-orientations are typically reversible when the source of energy is removed. Thus, the photochromic materials are chosen to darken in the presence of bright light, and then clear as the light intensity decreases. However, there may be some limitations to this responsiveness. Many photochromics absorb ultraviolet (UV) light and therefore may have limited response behind a window, such as when driving a vehicle, or riding in a train. Advances in photochromic technologies have extended absorption (activation) into the visible wavelength region for improved responsiveness. Another limitation can be how quickly the photochromic molecules respond to changes in absorbed energy; it would be clearly unacceptable (and possible dangerous) if it took half an hour for a lens to lighten when one walked inside from a bright sunlit area. Faster fade-back time is a very important factor in rating the performance of photochromic lenses. Similarly, quick response in darkening is a fundamental feature for effective photochromic lens performance.

As a practical matter, it has been found that the physical environment of the photochromic molecule may significantly affect the responsiveness and the lifetime of its performance. Since the color change (lightening and darkening) of the photochromic organic molecules is dependent on physical rearrangement and movement of the molecule, a certain amount of unhindered space is preferable to accommodate these processes more easily. In the gas or liquid phase, or in solution, this is not an issue, but when trapped within a solid matrix (within an eyewear lens, or applied onto a lens), many limitations can appear. In addition, the photochromic molecules can “fatigue” (i.e., lessen in coloration or response) due to exposure to environmental conditions or repeated movement of the physical bonds.

In addition, there is continued market demand for faster photochromic response, and better range of transmittance change for the lens (lighter in the rest state, and darker when exposed to activating energy). It has been difficult to achieve both “darker and faster” in the same product, especially when increased speed of fade-back is also required. Increased fade-back rate can be particularly beneficial for older persons (due to the slower active response of the eye), for highly light-sensitive individuals, and for those passing frequently between regions of different light intensity (such as encountered when driving through multiple tunnels, or passing through open forested areas).

In the development of photochromic optical materials, and particularly those used for photochromic eyewear lenses or spectacle lenses, there is a constant challenge to provide a medium for the photochromic materials(s) that will allow sufficient open space within its structure to accommodate the required molecular rotation or rearrangement of the photochromic molecules, while still maintaining the strength, rigidity and structural resilience needed for a reliable and long-lasting eyewear lens.

Use of photochromic laminates or embedded layers may offer an advantageous approach, because a more flexible or open layer containing photochromics can be stacked between more rigid layers (or optical materials) that provide the stability and structural properties needed for an optical article. However, while laminates may hold promise for ease of use, there have been problems or concerns with reliable, consistent and long-lasting adhesion within the multilayer structure, and between the laminate and other optical materials. Good adhesion can be particularly challenging when bonding dissimilar materials, and this problem is often encountered both within a multilayer laminate, and when embedding or joining a laminate to standard optical materials used, for example, to create spectacle lenses. This presents an area for further innovation and development.

In addition, further improvements are still sought for ease and efficiency of production of optical articles, reliability and robustness during additional processing of these articles, efficiency and cost-reduction of photochromic incorporation, and dependable performance and product integrity throughout extended product lifetime.

This disclosure presents a new approach to address the concerns described above.

### SUMMARY

In one embodiment, the product comprises a multilayer photochromic laminate comprised of a first polyvinyl alcohol layer with a first and second surface, a second polyvinyl alcohol layer with a first and second surface, and positioned between the first surface of the first layer and the first layer of the second layers is a third polyvinyl alcohol layer that comprises one or more photochromic materials.

In one embodiment, the multilayer photochromic laminate the third polyvinyl alcohol layer comprising one or more photochromic materials is directly bonded to the first surfaces of the first and second layers. In another embodiment, the third polyvinyl alcohol layer comprising one or more photochromic materials is acts as an adhesive layer between the first polyvinyl alcohol layer and the second polyvinyl alcohol layer.

In another embodiment, the photochromic multilayer laminate is free of polarizer components and polarizing coatings.

In another embodiment, at least one of the first or second polyvinyl alcohol layers of the laminate further comprises one or more additives selected from: electrochromics, thermochromics, non-photochromic nanoparticles, liquid crystals, dyes, tinting agents, pigments, mold release agents, UV absorbers, UV reflectors, UV stabilizers, visible light stabilizers, thermal stabilizers, antioxidants, optical brighteners, surfactants, plasticizers, polymer chain extenders, inert impact modifiers, IR reflectors, visible light filters, color blockers, selective light reflectors, and selective light absorbers. In one embodiment, the third polyvinyl alcohol layer of the photochromic multilayer laminate further comprises one or more of the following additives: UV absorbers, UV reflectors, dyes, pigments, tinting agents, color blockers, selective visible light absorbers, thermal stabilizers and UV stabilizers.

In an embodiment, the one or more photochromic materials can consist of silver halides, dichroic metal oxides, dichroic organic dyes, thermochromics, spiro(indoline)pyrans, naphthopyrans, benzopyrans, dithizonates, benzoxazines, spiro-oxazines, spiro(indoline)naphthoxazines, spiro-pyridobenzoxazines, anthroquinones, oxazines, indolizines, fulgides, or fulgimides. In another embodiment, at least one of the photochromic materials has the form of nanodroplets, photochromic nanoparticles or encapsulated forms having a capsule size in the range of 20 nm to 500 nm. In another embodiment, the third polyvinyl alcohol layer of the photochromic multilayer laminate comprises at least two photochromic materials, and at least one of these materials is activated by at least visible light.

In another embodiment, the photochromic multilayer laminate further comprises at least one of an additional element positioned on the second surface of the first layer or another additional element positioned on the second surface of the second layer. Each of these additional elements comprise one or more coatings selected from hard coatings, primer coatings, hydrophobic coatings, anti-fog coatings, moisture-barrier coatings, impact-resistant coatings, chemically-resistant coatings, mirror coatings, visible light anti-reflective coatings, UV anti-reflective coatings, electrochromic coatings, thermochromic coatings, photochromic coatings, polarizing coatings, polarizing multilayer thin film coatings, multilayer interference coatings, conductive coatings, visible light-filtering coatings, UV light-filtering coatings and infrared light-filtering coatings.

In another embodiment, the photochromic multilayer laminate further comprises an additional element positioned between the first surface of the first layer and the third layer, and another additional element positioned between the first surface of the second layer and the third layer, each of these additional elements comprising one or more polymers that are free of polyvinyl alcohol.

Another embodiment is a photochromic eyewear lens comprising the photochromic multilayer laminate. In an embodiment, the photochromic eyewear lens comprises the photochromic multilayer laminate, and an additional layer positioned on an outer surface of the laminate. In one embodiment, the additional layer for the eyewear lens comprises one or more optical materials selected from the group: thermoplastic polycarbonate, hard resin thermoset polymers, poly(urea-urethanes), polythiourethanes, episulfides, other sulfur-containing polymers with refractive indices higher than about 1.56, polystyrenes, polyamides, optical-grade nylon polymers, acrylics, polyacrylates, and polymethacrylates.

In another embodiment, the additional layer of optical material of the photochromic eyewear lens is positioned such that it will be nearer the eye when the lens is worn in front of the eye. In another embodiment, the additional layer of optical material of the photochromic eyewear lens further comprises one or more additives selected from mold release agents, thermal stabilizers, light stabilizers, UV absorbers, UV reflectors, antioxidants, chain extenders, optical brighteners, surfactants, plasticizers, polymer chain extenders, inert impact modifiers, UV stabilizers, visible light stabilizers, thermal stabilizers, antioxidants, optical brighteners, IR reflectors, and coloring additives.

In another embodiment, the photochromic lens further comprising an additional element bonded to the additional layer comprising optical material, and the additional element comprises one or more of the following: hard coatings, hydrophobic coatings, anti-fog coatings, moisture-barrier coatings, mirror coatings, visible light anti-reflective coatings, ultraviolet light anti-reflective coatings, electrochromic coatings, thermochromic coatings, photochromic coatings, polarizing coatings, polarizing multilayer thin film coatings, multilayer interference coatings, conductive coatings, visible light-filtering coatings, ultraviolet light-filtering coatings and infrared light-filtering coatings.

In another embodiment, the photochromic lens further comprising one or more of the following additives: mold release agents, thermal stabilizers, light stabilizers, UV absorbers, UV reflectors, antioxidants, chain extenders, optical brighteners, surfactants, plasticizers, polymer chain extenders, inert impact modifiers, UV stabilizers, visible light stabilizers, thermal stabilizers, antioxidants, optical brighteners, IR reflectors, and coloring additives.

In another embodiment, the photochromic eyewear lens further comprises another additional layer positioned on the other outer surface of the photochromic multilayer laminate, and this additional layer is comprised of one or more optical materials selected from is comprised of one or more optical materials selected from the group: thermoplastic polycarbonate, hard resin thermoset polymers, polyurea-urethanes, polythiourethanes, episulfides, other sulfur-containing polymers with refractive indices higher than about 1.56, polystyrenes, polyamides, optical-grade nylon polymers, acrylics, polyacrylates, and polymethacrylates.

In another embodiment, each of the additional layers comprised of optical materials for the photochromic eyewear lens further comprises one or more additives selected from the group: UV absorbers, UV reflectors, UV stabilizers, visible light stabilizers, thermal stabilizers, antioxidants, optical brighteners, surfactants, plasticizers, polymer chain extenders, inert impact modifiers, IR reflectors and coloring additives. In another embodiment, the photochromic eyewear lens further comprises at least one additional element positioned on at least one the additional layers comprised of optical material(s), and each of these additional element(s) comprise one or more coatings selected from hard coatings, primer coatings, hydrophobic coatings, anti-fog coatings, moisture-barrier coatings, impact-resistant coatings, chemically-resistant coatings, mirror coatings, visible light anti-reflective coatings, UV anti-reflective coatings, electrochromic coatings, thermochromic coatings, photochromic coatings, polarizing coatings, polarizing multilayer thin film coatings, multilayer interference coatings, conductive coatings, visible light-filtering coatings, UV light-filtering coatings and infrared light-filtering coatings.

In an embodiment, the photochromic eyewear lens is free of polarizer components and polarizing coatings.

### DESCRIPTION OF THE DRAWINGS

FIG. 1 shows a schematic side view of the layers in one exemplary embodiment of a multilayer laminate product.

FIG. 2 shows a schematic side view of another exemplary embodiment of a multilayer laminate product.

FIG. 3 shows a schematic side view of an exemplary embodiment in which the multilayer laminate is incorporated into an eyewear lens.

### DETAILED DESCRIPTION

Good photochromic performance and structural integrity of optical articles, and particularly eyewear lenses, is achieved according to the methods described herein by designing and using a multilayer laminate comprised of outer polyvinyl alcohol layers, and an inner polyvinyl alcohol layer further containing photochromics. The multilayer laminate exhibits an acceptable darkening range and good darkening speed. Surprisingly, the fade-back rate is very fast and was not compromised by incorporation of the photochromics into a solid layer. In addition, there is good adhesion within the laminate and between the laminate and optical materials used for eyewear lenses.

In one embodiment, an optical article comprising a photochromic multilayer laminate is provided. The optical articles described herein can be designed to transmit at least some light visible to the eye. In one aspect of this embodiment, the eyewear is provided external to the eye and not in direct contact with the eye. Eyewear lenses are optical articles worn in front of the eye. They may be plano, prescription or non-prescription lenses. Ophthalmic-quality eyewear lens products are lenses and lens blanks with sufficient structural integrity that they maintain the specified optical power of the finished eyewear lens, whether that specified power is zero (plano), plus, minus or multifocal. The specified optical power may be defined by an individual's prescription for correction of vision, or may be established according to industry or ophthalmic national and international standards for prescription and non-prescription lens products. Depending on the needs and desires of the individual, they may serve one or more purposes: correct vision, provide protection or improved comfort for the eyes, or be a fashionable accessory. Eyewear lenses are commonly mounted in eyeglass frames, rims, mountings, goggles, helmets, carriers, visors or other structures designed to hold lenses in front of the user's eyes. Eyewear lenses, as used herein, include lens blanks, semi-finished lens blanks, finished lens blanks, surfaced lenses, edged lenses and mounted lenses.

Many different optical materials are used to form eyewear lenses. It is desirable for such materials to exhibit low intrinsic haze or scatter, and to have sufficient chemical, physical and mechanical integrity to endure long-term wear and maintain the prescribed optical power. Among the materials known in the art are both inorganic and organic optical materials, such as metal oxide glasses with various refractive indices; optical-grade thermoplastics such as polycarbonates and other materials; hard resin thermoset polymers [based on polyol(allyl carbonate) polymerization, and particularly on reactions of diethylene glycol bis(allyl carbonate)], poly(urea-urethanes); polyurethanes; polythiourethanes; episulfides; other sulfur-containing polymers with refractive indices higher than about 1.56; polystyrenes; polyamides; certain enhanced optical-grade nylon polymers; acrylics; polyacrylates; polymethacrylates; polyurethane acrylates, polyurethane methacrylates and other organic polymers. The optical materials can also comprise mixtures of compatible organic polymeric materials. In other instances, the optical materials may comprise mixtures of organic and/or inorganic materials of crystalline, amorphous or polymeric structures. It is also common practice for the optical materials to include additives to modify the materials' optical, physical or chemical properties.

Eyewear lens products can also comprise combinations of optical materials as layered structures. Multilayer laminates may be used to provide additional features, such as enhanced optical performance, aesthetic effects, or physical or chemical stability. However, laminates may be challenging to incorporate during the heat, pressure or reactive environment of lens formation without compromising their advantageous properties. In addition, even if the desired properties are maintained during initial lens formation, they may not survive further lens processing such as edging, surfacing, polishing, surface treatments, coating, or mounting in eyewear frames, or may fail prematurely during use or during demanding product validation and testing. Such problems are particularly prevalent when the laminate and/or the optical materials have different chemical or physical structures.

Polyvinyl alcohol layers have been used previously for polarized film layers to be incorporated in optical articles, including eyewear lens products. While such layers are malleable and can be curved to accommodate the lens curvature for corrective optics, they tend to be moisture sensitive, and their added features may degrade when subjected to heat, chemical exposure, or the rigors of lens processing and wear. To protect fragile polarized polyvinyl alcohol films, one approach has been to place them on or between one or more layers of more robust materials, such as polycarbonate. However, some of these protective layers may be poorly compatible with subsequent optical materials needed for eyewear lenses.

For photochromic materials, polyurethanes or poly(urea-urethanes) have often been proposed as a suitable medium either as a separate layer, or an adhesive layer between other protective layers, as described, for instance, in U.S. Pat. Nos. 4,889,413, 6,797,383 B2, 6,986,946 B2, 7,350,917 B2 and 9,440,419 B2. While polyvinyl alcohol has been mentioned as a medium for photochromics, it is typically discussed as a liquid solution containing photochromics that can be coated onto a surface (for examples, as described in published U.S. Patent Applications 2015/0024126 A1 and 2017/0166806 A1).

Surprisingly, a multilayer laminate comprised of polyvinyl alcohol layers is effective both as a medium for photochromic materials and as a multilayer structure of sufficient robustness for use in optical articles. Given the known sensitivity of polyvinyl alcohol films, this was not expected. Incorporation of the photochromic material(s) into a polyvinyl alcohol layer also had the advantage of maintaining fast coloring and fade-back behavior, despite being incorporated into a solid matrix. In addition, good adhesion is achieved between many demanding optical materials and outer layers of the laminate comprised of polyvinyl alcohol.

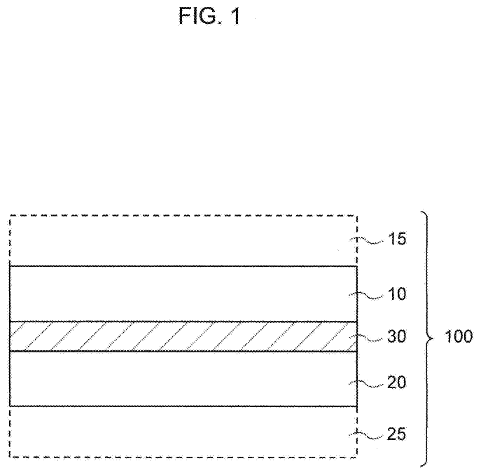

In an embodiment as shown in FIG. 1, the multilayer laminate 100 comprises a first layer 10 comprised of polyvinyl alcohol, a second layer 20 comprised of polyvinyl alcohol and a third layer 30 comprised of polyvinyl alcohol, wherein the third layer further comprises one or more photochromic materials. The third layer 30 is positioned within the multilayer laminate between the first layer 10 and the second layer 20.

The first and second layer may be identical in composition and thickness, or may differ from one another. For instance, layer 10 may be thinner than layer 20, or vice versa. One of these layers may be oriented or stretched differently from the other, exhibit different degrees of crosslinking, or have different molecular weight distributions. In one embodiment, layers 10 and 20 are essentially identical in chemical composition. In another embodiment, layers 10 and 20 are essentially identical in chemical composition, but differ in physical thickness. In another embodiment, one layer is stretched to a greater extent than the other layer.

For example, in some embodiments, layer 10 and layer 20 may each have thicknesses in the range of 100 nm-500 micrometers. In other embodiments, layer 10 and layer 20 may each have thicknesses: in the range of 100 nm-450 μm; in the range of 100 nm-400 μm; in the range of 100 nm-300 μm; in the range of 100 nm-250 μm; in the range of 100 nm-200 μm; in the range of 100 nm-175 μm; in the range of 100 nm-150 μm; in the range of 100 nm-100 μm; in the range of 100 nm-50 μm; in the range of 100 nm-25 μm; in the range of 100 nm-20 μm; in the range of 100 nm-2 μm; or in the range of 100 nm-1 μm. In other embodiments, layer 10 and layer 20 may each have thicknesses: in the range of 500 nm-500 μm; in the range of 500 nm-400 μm; in the range of 500 nm-300 μm; in the range of 500 nm-250 μm; in the range of 500 nm-200 μm; in the range of 500 nm-175 μm; in the range of 500 nm-150 μm; in the range of 500 nm-100 μm; in the range of 500 nm-80 μm; in the range of 500 nm-50 μm; in the range of 500 nm-20 μm; in the range of 500 nm-10 μm; or in the range of 500 nm-5 μm. In other embodiments, layer 10 and layer 20 may each have thicknesses in the range of: 1 μm-500 μm; 1 μm-400 μm; 1 μm-300 μm; 1 μm-250 μm; 1μm-200 μm; 1 μm-175 μm; 1 μm-150 μm; 1 μm-100 μm; 1 μm-50 μm; 1 μm-50 μm; 1 μm-20 μm and 1 μm-10 μm. In other embodiments, layer 10 and layer 20 may each have thicknesses: in the range of 10 μm-500 μm; in the range of 10 μm-300 μm; in the range of 10 μm-200 μm; in the range of 10 μm-150 μm; in the range of 10 μm-100 μm; or in the range of 10 μm-50 μm. In other embodiments, layer 10 and layer 20 may each have thicknesses in the range of: 20 μm-500 μm; 20 μm-400 μm; 20 μm-300 μm; 20 μm-250 μm; 20 μm-200 μm; 20 μm-175 μm; 20 μm-150 μm; and 20 μm-100 μm. In other embodiments, layers 10 and 20 may each have thicknesses in the range of: 50 μm-500 μm; 50 μm-400 μm; 50 μm-300 μm; 50 μm-250 μm; 50 μm-200 μm; 50 μm-175 μm; 50 μm-150 μm; and 50 μm-100 μm. In some embodiments, layers 10 and 20 may each have thicknesses in the range of 20 μm-500 μm; in other embodiments, layers 10 and 20 may each have thicknesses in the range of 50 μm-150 μm.

In other embodiments, layer 10 may have thicknesses in the range of 100 nm-200 μm, while layer 20 has thicknesses in the range of 100 nm-450 μm.

In other embodiments, layers 10 and 20 may have thicknesses in the range of 100 nm-500 μm, but the thickness of layer 10 is measurably less than the thickness of layer 20. Differences in film layer thicknesses are measurable by several techniques, such as profilometry, visible microscopy, scanning electron microscopy, transmission electron microscopy, interferometry, ellipsometry, infrared reflectance, visible reflectance, ultraviolet (UV) reflectance, x-ray reflectance, visible spectroscopy, UV spectroscopy, near infrared spectroscopy, infrared spectroscopy and the like.

As examples of such embodiments with measurably different thicknesses for layers 10 and 20, layer 10 may have a thickness in the range of 100 nm-100 μm, while layer 20 has a thickness in the range of 120 μm-500 μm. In another embodiment, layer 10 may have a thickness of 100 μm, while layer 20 has a thickness of 200 μm; in another embodiment, layer 10 may have a thickness of 150 μm, while layer 20 has a thickness of 200 μm; in another embodiment, layer 10 may have a thickness of 50 μm, while layer 20 has a thickness of 200 μm; in another embodiment, layer 10 may have a thickness of 20 μm, while layer 20 has a thickness of 80 μm; in another exemplary embodiment, layer 10 may have a thickness of 1 μm while layer 20 has a thickness of 3 μm; in another exemplary embodiment, layer 10 has a thickness of 100 nm while layer 20 has a thickness of 250 nm.

As other examples of embodiments with measurably different thicknesses for layers 10 and 20, thickness may be measured by, for example, profilometry, interferometry, ellipsometry, microscopy, reflectance or spectroscopy techniques, and layer 20 may have a thickness that is measurably greater (thicker) than the thickness of layer 10 by: 20 nm, 25 nm, 30 nm, 50 nm, 75 nm, 100 nm, 200 nm, 250 nm, 500 nm, 1 μm, 2 μm, 3 μm, 4 μm, 5 μm, 10 μm, 12 μm, 15 μm, 20 μm, 25 μm, 50 μm, 75 μm , 100 μm, 150 μm, 200 μm, 250 μm, 300 μm or 400 μm.

In other embodiments, layer 10 may be measurably thicker than layer 20. As examples of these embodiments, layer thickness may be measured by, for example, profilometry, interferometry, ellipsometry, microscopy, reflectance or spectroscopy techniques, and layer 10 may have a thickness that is measurably greater (thicker) than the thickness of layer 20 by: 20 nm, 25 nm, 30 nm, 50 nm, 75 nm, 100 nm, 200 nm, 250 nm, 500 nm, 1 μm, 2 μm, 3 μm, 4 μm, 5 μm, 10 μm, 12 μm, 15 μm, 20 μm, 25 μm, 50 μm, 75 μm , 100 μm, 150 μm, 200 μm, 250 μm, 300 μm or 400 μm.

For convenience and ease of discussion, layer 10 is shown in FIG. 1 as the uppermost layer of the laminate 100. In this configuration, layer 10 may be closer to the outer surface, or nearer the energy source (e.g., direct sunlight, sunlight filtered through windows, headlights, room lights, etc.) that will activate the photochromic layer 30. It will be clear to those of skill in the art that the laminate could be used with either layer 10 or 20 in the outermost position, and either orientation is within the scope of the disclosure.

Either or both of layers 10 and 20 may further comprise additional additives to alter or enhance their optical, physical and chemical properties. Additives can also be included to increase the stability of a particular material's properties, or to tailor them to a specific optical or physical performance. Additives include substances such as electrochromics, thermochromics, non-photochromic nanoparticles, liquid crystals, dyes, tinting agents, pigments, mold release agents, UV absorbers, UV reflectors, UV stabilizers, visible light stabilizers, thermal stabilizers, antioxidants, optical brighteners, surfactants, plasticizers, polymer chain extenders, inert impact modifiers, IR reflectors, visible light filters, color blockers, selective light reflectors, and selective light absorbers and the like.

In one embodiment, both layers 10 and 20 comprise additives designated for convenience of reference as “coloring additives.” These coloring additives are selected from the dyes, tinting agents, pigments, thermochromics, visible light filters, color blockers, selective visible light reflectors, and selective visible light absorbers. In one embodiment, at least one of layers 10 and 20 comprise at least one coloring additive. In one embodiment, at least one of layers 10 and 20 are transparent and have visible light luminous transmittance of greater than 75% as measured and calculated in accordance with the American National Standards Institute (ANSI) Z80.3-2018 Standard for Ophthalmics-Nonprescription Sunglass and Fashion Eyewear Requirements (illuminant C reference). In one embodiment, both layers 10 and 20 are transparent and have visible light luminous transmittance of greater than 75% as measured and calculated in accordance with the American National Standards Institute (ANSI) Z80.3-2018 Standard for Ophthalmics-Nonprescription Sunglass and Fashion Eyewear Requirements (illuminant C reference).

In addition, either or both of layers 10 or 20 can comprise optional discrete components such as displays, cameras, sensors, transmitters, receivers, electrical contacts, circuitry, wireless devices, marks and decorations.

One or more additives or components may be included in either of these layers, and different concentrations of additives may be present in either layer 10 or 20. For example, one or more additives may be included in one layer, but be absent or at a measurably different concentration in the other layer.

For example, in one embodiment, layer 20 comprises UV absorbers and/or UV stabilizers, such that when the multilayer laminate is used in eyewear lenses, it will block some UV exposure of the eye. In one exemplary embodiment in which layer 10 will be positioned nearer the light source that will activate the photochromic materials of layer 30, and layer 20 will be positioned farther away from the light source, layer 20 comprises UV absorbers and/or UV stabilizers, but layer 10 does not; in another embodiment in which layer 10 will be positioned nearer the light source that will activate the photochromic materials of layer 30, and layer 20 will be positioned farther away from the light source, layer 10 comprises lower concentrations of UV absorbers and stabilizers than layer 20.

In another exemplary embodiment, layer 10 comprises one or more coloring additives, such that the laminate has a discernible color and a permanently lower visible transmittance than a similar layer 10 without the given coloring additive(s). Discernible colors may be distinguishable by eye or by spectral measurement, and comprise tints, hues and shadings of colors. As non-limiting examples, discernible colors may include color families such as browns, red-browns, yellow-browns, chocolate-brown and other tinted browns; gray, neutral gray, blue-gray, rose-gray, green-gray or other tinted grays; rose to magenta tints; sea green, aqua and teal tints; and other combinations.

In another embodiment, one or more coloring additives are distributed in, on or over layer 10 such that they provide a gradient tint to the laminate; this gradient may proceed from higher transmittance at one edge of the surface of layer 10 to the opposite edge of the surface, or may be configured to give higher transmittance only within a select portion or region of the surface of layer 10.

In other embodiments, layer 20 may comprise one or more coloring additives as well as, or instead of, layer 10. The coloring additives of layer 20 may be similar, different or distinct from the coloring additives of layer 10. The coloring additives of layer 20 may be present at similar, different or distinct concentrations from those of layer 10. The coloring additives of layer 20 may be distributed in, on or over layer 20 to give uniform coloring or gradient tints that are similar, different or distinct from those of layer 10.

In other embodiments, layer 20 may comprise gradient tints as well as or instead of layer 10. The gradient tints of layer 20 may be similar, different or distinct from the gradient tints of layer 10.

As described, layers comprising coloring additives may exhibit a uniform coloration over the entire layer, areas of higher transmission or different coloration, and gradient tints. These variations can be designed into the layers and will depend on how the coloring additives are incorporated and distributed in the layers. In addition, when a layer comprises coloring additives that are thermochromics, the coloring or visible transmittance of the layer will change depending on the thermal environment; by use of thermochromics, variable coloration and/or variable transmittance can be designed into the layer.

In another embodiment, either or both of layers 10 or 20 comprise one or more components to enable displays or sensors on a lens incorporating the multilayer laminate. Other combinations of additives and/or components that may be included in layer 10 or 20 will be apparent to those skilled in the art.

Layer 30 is comprised of polyvinyl alcohol, but also comprises one or more photochromic materials. Layer 30 may have a similar thickness to either or both layers 10 and 20. This may offer advantages such as ease of manufacturing, and common sources of materials.

Alternatively, layer 30 may comprise a thinner polyvinyl alcohol layer than either layer 10 or layer 20. A relatively thin photochromic layer 30 can provide several advantages. First, photochromic substances are very expensive, so it advantageous to use as little as needed to achieve the desired effect. Secondly, when the photochromic molecules are activated by exposure to light energy, they may darken, and therefore mask photochromic molecules deeper in the structure from reacting; again, this can be wasteful of materials and limited funds. On the other hand, if there is sufficient penetration of activating energy into a thicker layer and that layer is not uniform, then non-uniform darkening can occur, and this gives an undesirable, blotchy appearance to the lens. In addition, a relatively thin layer comprising photochromic materials may allow the overall thickness of the multilayer laminate to be less, and therefore it will be easier and less intrusive to include within an eyewear lens.

In another embodiment, layer 30 may be thicker than either or both of layers 10 and 20. This may offer advantages for ease of handling during incorporation of the photochromic materials, as well as during further processing into the laminate with layers 10 and 20. A thicker layer 30 may provide more volume or surface area for efficient and effective incorporation of photochromic material(s). In addition, this thicker layer 30 need not jeopardize the overall thickness of the multilayer laminate if layers 10 and 20 are acceptably thinner.

Surprisingly, the inventors found that even when layers 10 and 20 were measurably thinner that layer 30, the photochromic performance, moisture stability and ability to handle the multilayer laminate was not compromised. This was unexpected, because typically in laminates, the outer layers are essential to protect the inner layer (here layer 30) from environmental, chemical or physical degradation. Therefore, common practice for laminate construction has the outer layers thicker and/or of more robust material than the inner, protected layer. The inventors found that this was not a requirement for the unique laminate described herein.

Layer 30 may have a thickness in the range of 50 nm-500 μm. When a relatively thin photochromic layer 30 is employed, it may have a thickness in the range of: 50 nm-300 μm; 50 nm-250 μm; 50 nm-200 μm; 50 nm-150 μm; 50 nm-100 μm; 50 nm-76 μm; 50 nm-75 μm; 50 nm-50 μm; 50 nm-45 μm; 50 nm-30 μm; 50 nm-25 μm; 50 nm-20 μm; 50 nm-10 μm; 50 nm-5 μm; 50 nm-3 μm; 50 nm-1 μm; 50 nm-500 nm; 50 nm-250 nm; 50 nm-200 nm; or 50 nm -100 nm. In another embodiment of an exemplary photochromic layer, layer 30 may have a thickness in the range of: 100 nm-500 μm; 100 nm-300 μm; 100 nm-250 μm; 100 nm-200 μm; 100 nm-100 μm; 100 nm-80 μm; 100 nm-76 μm; 100 nm-50 μm; 100 nm-45 μm; 100 nm-30 μm; 100 nm-25 μm; 100 nm-20 μm; 100 nm-10 μm; 100 nm-5 μm; 100 nm-3 μm; 100 nm-2 μm; 100 nm-1 μm; 100 nm-500 nm; 100 nm-250 nm; or 100 nm-200 nm. In another embodiment of an exemplary photochromic layer, layer 30 may have a thickness in the range of: 1 μm-500 μm; 1 μm-300 μm; 1 μm-250 μm; 1 μm-200 μm; 1 μm-150 μm; 1 μm-100 μm; 1 μm-50 μm; 1 μm-30 μm; 1 μm-25 μm; 1 μm-20 μm; 1 μm-10 μm; 1 μm-5 μm; 1 μm-3 μm; or 1 μm-2 μm. In another embodiment of an exemplary photochromic layer, layer 30 may have a thickness in the range of: 10 μm-500 μm; 10 μm-300 μm; 10 μm-250 μm; 10 μm-200 μm; 10 μm-150 μm; 10 μm-100 μm; 10 μm-76 μm; 10 μm-75 μm; 10 μm-50 μm; 10 μm-45 μm; 10 μm-30 μm; 10 μm-25 μm; or 10 μm-20 μm. In another embodiment of an exemplary photochromic layer, layer 30 may have a thickness in the range of: 50 μm-500 μm; 50 μm-300 μm; 50 μm-250 μm; 50 μm-200 μm; 50 μm-150 μm; 50 μm-100 μm; 50 μm-76 μm; or 50 μm-75 In another embodiment of an exemplary photochromic layer, layer 30 may have a thickness in the range of: 100 μm-500 μm; 100 μm-300 μm; 100 μm-250 μm; 100 μm-200 μm; or 100 μm-150 μm.

Analogous to layers 10 and 20, layer 30 may further comprise additives or components to maintain, modify, enhance, or expand its attributes and performance. Such additives or components should not compromise the photochromic performance of layer 30, but they may, by design, modify it. As one non-limiting example, UV absorbers may be added to layer 30 to temper UV activation of one or more photochromic materials and balance their responsiveness or coloration relative to standard performance parameters or the behavior of other include photochromic materials. This could allow active, fast photochromics to be used, but prevent the laminate (or eyewear lens incorporating the laminate) from becoming too dark or too highly colored. Similarly, coloring additives, and particularly dyes, pigments or tinting agents, may be included to tailor the initial color of layer 30 and/or laminate 100, or to modify the perceived color during and upon activation of the photochromic material(s) in layer 30. In another example, thermal or UV stabilizers may be included to extend the useful lifetime of the laminate. In another embodiment, electrical contacts or circuitry may be included to complement or enable devices within layer 30, or to support active or passive components in layers 10 and/or 20. Other combinations or inclusions of additives or components for layers 10, 20, and 30 will be understood by those of skill in the art to be within the scope of this disclosure.

Each of layers 10, 20, and 30 may comprise stretched or unstretched polyvinyl alcohol. Interestingly, stretching or linearly aligning the layer may not be essential to performance of the resultant multilayer laminate. The polyvinyl alcohol comprising layers 10, 20, and 30 may each have similar, different or distinct crystallinities, molecular weights or cross-linking densities. In one embodiment, the polyvinyl alcohol crystallinity, molecular weight and cross-linking density may be similar for each of the three layers; in another embodiment, layers 10 and 20 may have similar polyvinyl alcohol crystallinity, molecular weight and cross-linking density, but one or more of these properties may be different for the polyvinyl alcohol that comprises layer 30.

The polyvinyl alcohol layers 10, 20 and 30 may each be formed by various deposition techniques known in the state of the art, including techniques such as spin casting, spin coating, pouring, settling, roll-to-roll casting, doctor blade, curtain coating, dip coating, roll coating, roller deposition, wet deposition, spray coating, spray casting and other methods of forming solid films or layers.

In addition, each of layers 10, 20 and 30 may be created by two or more depositions of polyvinyl alcohol material, and such composite layers may be formed by one or more deposition techniques. Thus, layers 10, 20 and 30 may comprise a single deposition of polyvinyl alcohol, or a composite of multiple formations of polyvinyl alcohol material(s). As one example, layer 10 and/or 20 may be created by one sheet of polyvinyl alcohol formed by roll-to-roll casting, with added polyvinyl alcohol applied to the sheet by spin coating. As another non-limiting example, layer 30 may be created by one sheet of polyvinyl alcohol formed by roll-to-roll casting, with added polyvinyl alcohol applied to the sheet by doctor blade. As other non-limiting examples, layer 30 may be created by one sheet of polyvinyl alcohol formed by pouring or settling, with added polyvinyl alcohol applied to the sheet by doctor blade or dip coating.

For these composite layers, each polyvinyl alcohol sheet, film or deposition (for convenience, designated a “polyvinyl alcohol element”) of a given composite layer is directly joined to its adjacent polyvinyl alcohol layer element of the composite layer with no intervening material except for water or polyvinyl alcohol; that is, if any of layers 10, 20 and 30 are created as a composite layer of polyvinyl alcohol materials, the polyvinyl alcohol elements of that layer may, if desired, be joined by water and/or polyvinyl alcohol, but none of the polyvinyl alcohol elements are joined to another polyvinyl alcohol element by non-polyvinyl alcohol polymers, adhesives, glues or joining materials. In exemplary embodiments, the polyvinyl alcohol elements may be joined to each other by: application of water to one or more of the polyvinyl alcohol elements; application of liquid polyvinyl alcohol to one or more of the polyvinyl alcohol elements; application of a mixture of water and liquid polyvinyl alcohol to one or more of the polyvinyl alcohol elements; application of pressure to two or more of the polyvinyl alcohol elements; or application of heat, infrared energy, plasma, or ultraviolet energy to one or more of the polyvinyl alcohol elements.

Such composite layers may be useful to incorporate additional properties into a given layer, or to enhance or tailor certain properties of layers 10, 20 or 30. For example, commercially available polyvinyl alcohol sheets made by roll-to-roll casting may provide a basic stable structure for a given layer, and desired additives, including coloring additives, may be absorbed into or through the surface of the sheet. However, some desired additive(s) (for example, a UV absorber of large molecular weight) may not be readily absorbed into this roll-to-roll formed sheet. Instead, in an exemplary embodiment, the additive may be incorporated into a separate solution of polyvinyl alcohol, and dip coated onto the sheet to make a composite layer with expanded functionality. In another example, a discrete component may be incorporated into or onto a polyvinyl alcohol sheet, but would be susceptible to damage or dysfunction if other desired additives for the layer were included in that sheet; in this alternative embodiment, one or more other polyvinyl alcohol elements comprising the desired additive(s) are joined with the polyvinyl alcohol sheet having the discrete component to create a functional composite layer. As another example, layer 30 may comprise a composite of multiple polyvinyl alcohol elements that comprise different photochromic materials or different concentrations of photochromic materials or other additives. This may be especially advantageous if the photochromic materials or other additives are incompatible with each other, or if better photochromic performance is desired, but additional photochromic materials or other additives cannot be added to a single polyvinyl alcohol element without jeopardizing its physical, optical or chemical properties. In other embodiments, the composite layer 30 may comprise multiple polyvinyl alcohol elements having different physical thicknesses, with each element further comprising (with respect to the other elements): the same or different photochromic materials; the same or different concentration of photochromic material(s); the same or different distribution of photochromic material(s) within or across the element; or the same or different additives. In other examples, one or more of layers 10, 20 or 30 may comprise a composite of multiple polyvinyl alcohol elements in which one or more of the polyvinyl alcohol elements comprise different thicknesses, different additives, different components, or with different polyvinyl alcohol crystallinities, molecular weights and/or cross-linking densities to tailor the final composite layer's physical, optical or chemical-resistant properties.

FIG. 1 shows an exemplary embodiment comprising at least three polyvinyl alcohol layers (layers 10, 20 and 30) in the multilayer laminate, with layers 10 and 20 as the outer polyvinyl alcohol layers of the laminate structure. In one embodiment, photochromic polyvinyl alcohol layer 30 may be the only laminate layer between layers 10 and 20. In another embodiment, photochromic layer 30 not only comprises photochromic material(s) but also acts as an adhesive layer to join layers 10 and 20 within laminate 100.

Each of layers 10 and 20 comprise a first surface and a second surface. In one embodiment, layer 30 is directly adhered to a first surface of layer 10 and to a first surface of layer 20, and layer 30 functions also as the adhesive material that binds these layers. In one exemplary embodiment of such a configuration, the photochromic polyvinyl alcohol polymeric material of layer 30 may be applied in a liquid or only partially cured state to either or both layers 10 and 20, and then allowed to solidify or cure to bond the three layers directly together. In another embodiment, layer 30 may be a solid layer positioned between layers 10 and 20, and then the three layers subjected to conditions that will cause bonding between the discrete polyvinyl alcohol layers; such conditions may include mild heat (e.g., <100° C.), humidity, pressure slightly above atmospheric, or combinations thereof; or other joining techniques such as controlled exposure to plasma, or irradiation. This direct adhesive bonding via layer 30 is advantageous for simplicity and durability of construction, because it presents fewer interfaces for potential delamination, and the similar materials bond strongly, with high resistance to future environmental, chemical or physical stresses.

Further, other multilayer laminate structures are desirable, and additional embodiments are described below.

It is also within the scope of the product described herein to position the photochromic polyvinyl alcohol layer 30 within the multilayer laminate 100 and between layers 10 and 20 by sandwiching, laminating, adhering, bonding, fusing, joining or mounting layer 30 in, on or against one or more other elements of the laminate. In another embodiment as illustrated schematically by FIG. 1, the three polyvinyl alcohol layers (10, 20 and 30) comprising the multilayer laminate are adhered to each other by applying a very thin adhesive coating or solution between two or more of the polyvinyl alcohol layers, and allowing the adhesive material to cure and bond the adjacent surfaces of the polyvinyl alcohol layers. For example, in exemplary embodiments, adhesive may be incorporated between the first surface of layer 10 and layer 30, between the first surface of layer 20 and layer 30, or between the first surface of layer 10 and layer 30 and also between the first surface of layer 20 and layer 30. These very thin adhesive coatings or solutions are not shown in FIG. 1. Examples of such adhesives include water, water-based adhesives, polyurethane adhesives, acrylate-based adhesives and the like; the same or different adhesives, and/or different amounts of an adhesive may be used to bond different adjacent surfaces to layer 30.

In these varied embodiments, laminate 100 comprises photochromic layer 30 positioned between layers 10 and 20, or more specifically, the laminate 100 comprises a structure such that layer 30 is positioned between the first surface of layer 10 and the first surface of layer 20. In one embodiment, layers 10, 20 and 30 are directly bonded to each other; in another embodiment, they are laminated to each other; in another embodiment, they are joined adhesively with water; in another embodiment, one or more of layers 10, 20 and 30 are composite layers and each of layers 10, 20 and 30 are either directly bonded to each other or bonded to each other with an adhesive.

Advantageously, the multilayer structure of laminate 100 enable a more accurate, consistent positioning and location of the photochromic layer, both within the laminate and particularly, within an eyewear lens. In addition, the multilayer structure improves the stability of the photochromic performance, without hindering its fast response or significantly decreasing its range of coloration.

Despite the fact that layers 10, 20 and 30 are each comprised of polyvinyl alcohol, a material that is inherently sensitive to moisture degradation, the laminate 100 has improved moisture stability. This appears to be in part due to the combination of the multiple but discrete polyvinyl alcohol layers.

In this innovative multilayer structure, the degree of cross-linking and other material characteristics of the at least three polyvinyl alcohol layers creatively controllable to reduce haze and improve photochromic and optical performance. For instance, to improve its moisture stability, polyvinyl alcohol is typically stretched or treated to increase cross-linking and/or increase crystallinity. However, increased cross-linking causes increased haze and scatter, which is highly detrimental to good optical imaging and to visual acuity. Layers 10 or 20 may optionally be stretched or cross-linked, but such actions do not appear essential to the photochromic performance or moisture stability of laminate 100. With the multilayer laminate, it is not necessary to highly cross-link layers 10 and/or 20—and yet the laminate structure shows good protection of the photochromic performance even in wet environments. Layers 10 and 20 may also be comprised of polyvinyl alcohol with a wide range of crystallinities and molecular weight, and these layers may be formed of polyvinyl alcohol with higher molecular weights or higher degrees of crystallinity than layer 30. Surprisingly, the innovative multilayer structure of laminate 100 showed less moisture or water damage to the inner photochromic layer 30 even if layer 30 was not highly cross-linked or stretched. Too much stretching or cross-linking of layer 30 degrades its photochromic performance; this may be caused by damaging the photochromic structures within the polyvinyl alcohol matrix, or limiting the space available for needed, free reorientation of the photochromic molecules. Being less stretched or highly cross-linked, layer 30 also showed less haze, enabling better optical performance in both the laminate and in the final optical article incorporating the laminate; the lower haze of layer 30 and hence the entire laminate 100 has less deleterious effects to the summation of all optical losses for the final product.

In addition, while layer 30 may be comprised successfully from polyvinyl alcohol with a range of molecular weights, too low a molecular weight may be problematic due to higher moisture sensitivity. While the moisture sensitivity of such a low molecular weight material can be improved by stretching, cross-linking or increasing crystallinity, each of these actions may lead to unacceptable haze or degradation of photochromic performance in layer 30. Conversely, material that is highly hydrolysed, or has too high a molecular weight may have better moisture stability, but can exhibit unacceptable haze. The multilayer laminate structure described herein addresses these issues. The laminate polyvinyl alcohol layers are designed and combined such that the properties of the polyvinyl alcohol comprising layer 30 are optimized for photochromic performance without excessive moisture sensitivity, and the properties of the polyvinyl alcohol comprising layers 10 and 20 are selected and optimized to maintain layer 30's properties, even when subject to moisture exposure and the rigors or long-term use in eyewear lenses, and increase the ease of handling, precision placement and compatibility with the multiple optical materials employed in subsequent lens manufacture and use.

Controlling the moisture sensitivity of layer 30 is important to the performance of laminate 100, and when incorporated into optical articles. If the moisture sensitivity is not controlled, layer 30 exhibits high haze that can compromise the optics of laminate or the optical article. Controlled but gentle drying of layer 30 is beneficial to increase the moisture stability of this layer and the subsequent laminate; it seems drying reduces uncontrolled side reactions with water or humidity. This drying may be conducted at room temperature, or with mild heating (for example, less than about 100° C., or in another instance, less than about 70° C.). If the moisture sensitivity is not controlled, optical articles (such as surfaced eyewear lenses) incorporating laminate 100 will show unacceptable moisture damage upon exposure to extended testing (e.g., 72 hours at 65° C. and 100% humidity) in environmental chambers such as QCT® condensation testers (Q-Lab Corp., Westlake, Ohio).

In addition, either or both of layers 10 and 20 may comprise additional coatings to enhance, modify or expand the optical, chemical or physical attributes and performance of the multilayer laminate. Such optional coatings are indicated with a dashed outline as elements 15 and 25 in FIG. 1. As shown, in one embodiment, such coatings would be positioned on one or more of the outer layer surfaces of the multilayer laminate. In this embodiment, one recognizes that each of layers 10 and 20 have a first surface and an opposite second surface. Layer 30 is positioned between layers 10 and 20, and more precisely, is positioned between the first surface of layer 10 and the first surface of 20. In one exemplary embodiment, layers 10 and 20 are directly adhered via photochromic layer 30; in other exemplary embodiments, very thin adhesive coatings or solutions are cured to bond either or both of the first surface(s) of layer 10 and 20 to layer 30. However, in other embodiments, the opposite, second surfaces of either layer 10 or 20 may each comprise or support coatings. Such optional coatings cover the entire second surface of the given layer, or extend over less than the entire area of a layer's second surface.

The optional coatings (indicated by elements 15 and 25 in FIG. 1) incorporated with the multilayer laminate 100 can comprise applied coatings such as hard coatings, primer coatings, hydrophobic coatings, anti-fog coatings, moisture-barrier coatings, impact-resistant coatings, chemically-resistant coatings, mirror coatings, visible light anti-reflective coatings, UV anti-reflective coatings, electrochromic coatings, thermochromic coatings, photochromic coatings, polarizing coatings, polarizing multilayer thin film coatings, multilayer interference coatings, conductive coatings, other visible, UV or infrared light-filtering coatings and other coatings to tailor the optical, chemical or mechanical properties of the lens. These coatings may comprise gradients of color or other optical, chemical or mechanical properties.

When polarizing coatings are optionally included in elements 15 and/or 25, they may comprise single layer coatings, supported film coatings, multilayer thin film coatings, multilayer polymeric film stacks, wire grids, or include an applied or embedded structure. In some embodiments, polarizing coatings are selected from linear, gradient linear, elliptical, circular or variable polarizers, and can comprise solid, mixed, multiple or gradient tints.

The coatings of elements 15 and 25 can comprise one or more layers; for instance, multilayer interference coatings of dielectric, metal/dielectric or conductive/insulating materials can range from two to several hundreds of layers. In addition, one or more types of coatings may be used in combination as either element 15 or 25. Elements 15 and 25 may be the same or different, and may comprise the same or different coatings and/or coating combinations.

The optional element(s) 15 and 25 of multilayer laminate 100 can also comprise optional treatments to change the surface properties of the laminate or the respective layer 10 or 20. In this case, the optional element(s) 15 and/or 25 identify that the second surface of respective layers 10 and/or 20 have been altered physically or chemically by the applied surface treatment. Some optional treatments can act as moisture barriers or release agents, or can improve anti-fogging or ease of cleaning. Other optional treatments can increase resistant to scratches, impact, or chemicals; or enhance adhesion of subsequent coatings, layers, or materials. Such treatments can be achieved using techniques such as controlled exposure to atmospheric plasma, radio-frequency plasma, microwave plasma, UV irradiation, infrared irradiation, chemicals, ionic bombardment, sputtering, etching, surface abrasion and other methods.

In an embodiment, at least one of the surfaces of one or more of the layers in the multilayer laminate 100 may be treated to enhance adhesion of the individual layers within the laminate. In another embodiment, the second surface of at least one of layer 10 or layer 20 is subjected to treatment to enhance subsequent adhesion of the laminate 100 to optical material in an eyewear lens. In an embodiment, at least one of layer 10 or layer 20 is subjected to treatment to enhance subsequent adhesion using one or more techniques selected from controlled exposure to atmospheric plasma, radio-frequency plasma, microwave plasma, UV irradiation, infrared irradiation, chemicals, ionic bombardment, sputtering, etching, and surface abrasion.

Layer 30 comprises at least one photochromic material. Photochromic materials can include inorganic materials such as silver halides and dichroic metal oxides, as well as organic materials including some dichroic organic dyes, thermochromics (particularly metallo-organic thermochromics), and many different aromatic, hetero-aromatic and ring compounds such as spiro(indoline)pyrans, naphthopyrans, benzopyrans, dithizonates, benzoxazines, spiro-oxazines, spiro(indoline)naphthoxazines, spiro-pyridobenzoxazines, anthroquinones, oxazines, indolizines, fulgides, fulgimides and other photochromic materials known in the art. These are exemplary photochromic materials. Other photochromic materials or agents can be incorporated in, with or on layer 30. One or more different photochromic materials, different types of photochromic materials or different families of photochromics can be combined for use in layer 30 and may be present at different concentrations or at different locations on, across or within layer 30. Some exemplary embodiments are described herein.

In one embodiment, one or more photochromic materials are combined such that the laminate (and an eyewear lens that incorporates the laminate) exhibits a neutral grey color when the photochromic materials are activated. In another embodiment, layer 30 comprises one or more photochromic materials that provide an identifiable color other than grey when activated. In another embodiment, the laminate (and an eyewear lens that incorporates the laminate) comprises one or more photochromic materials that provide a light tint to the eyewear in the rest (unactivated) state, but a darker tint when activated by visible and/or UV light.

In another embodiment, the photochromic material(s) of layer 30 of laminate 100 are designed and incorporated such that when they are activated, discernible differences in color hue or depth of tint are observed under different lighting intensities or wavelengths of exposure.

In other embodiments, the photochromic material(s) are distributed or incorporated alone or in combination with other additives in layer 30, or in combination with the other layers of the laminate 100 and their additives, such that they provide a lighter tint to the eyewear lens at rest and a darker tint or color upon activation with visible and/or ultraviolet light. In other embodiments, the photochromic material(s) are distributed or incorporated alone or in combination with other additives in layer 30, or in combination with the other layers of the laminate 100 and their additives, such that, upon activation with visible and/or ultraviolet light, they impart a solid or gradient tint to the eyewear lens. In other embodiments, the distribution or incorporation of photochromic material(s)—and their combination with other additives in layer 30, layers 10 and/or 20, or within the eyewear lens—impart solid or gradient tints to the laminate and eyewear lens that vary depending upon ultraviolet or visible light exposure.

Various weight percentages (relative to the total mass of layer 30) of the one or more photochromic materials can be used. In general, the degree of coloring (and/or darkening) of the resultant optical article increases with the amount of photochromic material(s) added. However, given the high cost of these photochromic materials and the need for some minimum transmittance through the laminate (or the eyewear lens incorporating the laminate), the weight percentage is kept as low as possible while still achieving effective darkening. In some embodiments, less than about 10% by weight, less than about 8% by weight, less than about 5% by weight, less than about 4% by weight, less than about 3.5% by weight, less than about 3%, less than about 2.9% by weight, less than about 2.8% by weight, less than about 2.7% by weight, less than about 2.6% by weight, less than about 2.5% by weight, less than about 2.4% by weight, less than about 2.3% by weight, less than about 2.2% by weight, less than about 2.1% by weight by weight, less than about 2% by weight, less than about 1.9% by weight, less than about 1.8% by weight, less than about 1.7% by weight, less than about 1.6% by weight, less than about 1.5% by weight, less than about 1.4% by weight, less than about 1.3% by weight, less than about 1.2% by weight, less than about 1.1% by weight, less than about 1% by weight, less than about 0.9% by weight, less than about 0.8% by weight, less than about 0.7% by weight, less than about 0.6% by weight, less than about 0.5% by weight, less than about 0.4% by weight, less than about 0.3% by weight, or less than about 0.25% by weight of photochromic materials are used. These percentages by weight refer to the total combined weight of photochromic materials in layer 30; when layer 30 comprises two or more photochromics, the individual percentages by weight of the discrete photochromics may be less than these values.

In another embodiment, the total amount of photochromic materials included in layer 30 is between and includes any two of the foregoing values. In an embodiment, the total amount of photochromic materials included can be less than about 8% but more than about 0.25% by weight; in another embodiment, less than about 6.5% but more than about 0.3% photochromic materials are included by weight; in another embodiment less than about 5% but greater than about 0.5% by weight; in another embodiment, less than about 5% but more than about 1% by weight of photochromic materials are included.

In one embodiment, layer 30 and/or its combination with the other layers of laminate 100 can be advantageously designed to make use of the one or more photochromics that are activated by different wavelength regions (such as UV exposure, near UV exposure, near-visible light exposure or blue light exposure) to change color, hue, shade and/or depth of tint. Most commercially available photochromic materials are only activated by UV light, but a few photochromic materials absorb and react under visible light as well as ultraviolet light, and/or have an absorption tail that extends into the visible range (for example, near the blue light edge) to allows some response to visible light. In addition, some photochromic materials are known to activate upon visible light exposure. Photochromic materials with visible light response or activation can provide additional UV or blue light filtering to the laminate 100 and to eyewear lenses that incorporate the laminate. In addition, the expansion of photochromic activation into the visible region may provide beneficial darkening or coloration in bright visible light situations, such as intense reflections off water, snow or mirror-like surfaces. By use or combination of photochromic materials that are activated by different light frequencies, including one or more materials that are activated by at least visible light, the inventors found that the eyewear lens can be advantageously tailored to respond to direct sunlight, various artificial light sources, or to light filtered through windows or windscreens.

In one embodiment, layer 30 comprises one or more photochromic materials that are activated by at least visible light; in another embodiment, layer 30 comprises one or more photochromic materials that are activated by both ultraviolet and visible light. In another embodiment, layer 30 comprises at least one photochromic material that is activated by ultraviolet light and at least one photochromic material that is activated by at least visible light.

In one embodiment, the photochromic material(s) can be dispersed in the photochromic polyvinyl alcohol layer 30. This can be accomplished, for example, by introducing the photochromic material(s) into a solution of polyvinyl alcohol before the layer is allowed to solidify. In another example, a polyvinyl alcohol layer may be placed in contact with a solution or dispersion comprising photochromic materials for a sufficient time and at such conditions of temperature, humidity, etc. that the photochromic material(s) migrate into the polyvinyl alcohol layer.

In another embodiment, photochromic material(s) can be imbibed into the polyvinyl alcohol layer to form layer 30. In imbibition, the polyvinyl alcohol layer may be subjected to a heated solution or vapor comprising photochromic material(s) for sufficient time and under process conditions that allow penetration of the photochromic material(s) through the surface and into at least some portion of the thickness of the layer. This may result in a gradient of the concentration of photochromic material(s) within the total thickness of the layer; however, the photochromic performance may still be successful if enough photochromic molecules are present.

Other techniques for introduction of dyes or photochromic materials into and/or onto optical materials also may be employed. Some of these techniques are described, for example, in U.S. Pat. Nos. 4,968,454, 5,882,556, and 6,146,554, and in U.S. Patent Applications 2015/0024126 A1, 2017/0166806 A1 and 2018/0354211 A9. Different techniques may be used for different photochromic materials. In addition, different techniques or modified conditions may be employed depending on whether the photochromic material(s) that further comprise layer 30 are to be incorporated into a solid polyvinyl alcohol layer; a partially cured polyvinyl alcohol layer; polyvinyl alcohol material (in a liquid, gelled or solid state) that acts additionally as an adhesive layer within the multilayer laminate 100; or that is incorporated in polyvinyl alcohol layer 30 that is directly joined or bonded to layers 10 and/or 20. For example, an adhesive layer structure for layer 30 may not be as solid or rigid as that used in the laminate for other embodiments of layer 30; in another example, there may be other, different and plausible options for introduction of the photochromics materials into layer 30 if layer 30 is joined to layer 10 and/or 20 by adhesive materials.

The photochromic material(s) can comprise various forms when introduced and incorporated into layer 30. These forms or structures include, for example, powder; particles or smaller nanoparticles; droplets or smaller nanodroplets, including nanodroplets comprising solvents, oils, solutions or mixtures that dissolve, suspend or entrap photochromics; photochromic material trapped or dispersed within oils or suspensions; photochromic materials encapsulated in hollow spheres of other polymers; photochromic materials encapsulated in a polymer matrix; and photochromic materials in solutions or dispersions encapsulated within spheres of other polymers. In one embodiment, the photochromic material(s) are present as particles or nanoparticles in layer 30; in another embodiment, the photochromic material(s) are present as droplets or nanodroplets in layer 30; in another embodiment, the photochromic material(s) are encapsulated within nanocapsules that are present or added to layer 30.

Nanoparticles, nanodroplets and nanocapsules have diameters or maximum dimensions of 1000 nm or less. Photochromic nanoparticles comprise single or aggregate molecules of photochromic material(s). Nanodroplets have dimensions of about 5 nm to 1000 nm; in one embodiment, the nanodroplets have dimensions in the range of about 5 nm to 500 nm; in other embodiments, the nanodroplets have dimensions in the range of about 10 nm to 350 nm, about 20 nm to 250 nm, about 25 nm to 200 nm, or about 50 nm to 150 nm. The nanodroplets comprise liquids and photochromic material(s) that are dispersed, dissolved, suspended or entrapped within these small droplets. Exemplary liquids to comprise these photochromic nanodroplets include organic solvents, inorganic solvents, water, oils, low viscosity polymers, low molecular weight polymers, organic solutions and mixtures thereof.

In one embodiment, the photochromic nanodroplets are formed by first creating a mixture or solution of the liquid(s) and photochromic material(s) for the nanodroplets, combining this mixture with an immiscible emulsion medium to yield a pre-emulsion liquid preparation, and forming a dispersion of photochromic nanodroplets within an emulsion by subjecting the pre-emulsion liquid preparation to techniques such as high pressure or ultra-sonic energy. The dispersion of photochromic nanodroplets within the emulsion is subsequently used to form layer 30. In some embodiments, the emulsion medium may comprise liquid polyvinyl alcohol, mixtures of liquid polyvinyl alcohol and water, mixtures of polyvinyl alcohol and other solvents immiscible with the photochromic droplet liquids, and combinations thereof.

In other embodiments, the photochromic material(s) are encapsulated prior to or during incorporation into layer 30. In one such embodiment, the photochromic material(s) are encapsulated in hollow spheres of a polymeric material different from polyvinyl alcohol; in another embodiment, the photochromic material(s) comprise a solution or dispersion of the photochromic molecules that is encapsulated within spheres of a polymeric material different from polyvinyl alcohol. In some embodiments when the photochromic material(s) are encapsulated, the capsules may be of a size in the range of 10 nm-1000 nm, in the range of 20 nm-1000 nm, or in the range of 20 nm-500 nm.

In some embodiments, the form of the photochromic materials dispersed or incorporated within layer 30 is selected from nanoparticles, nanodroplets and encapsulated forms having a capsule size in the range of 20 nm-500 nm.

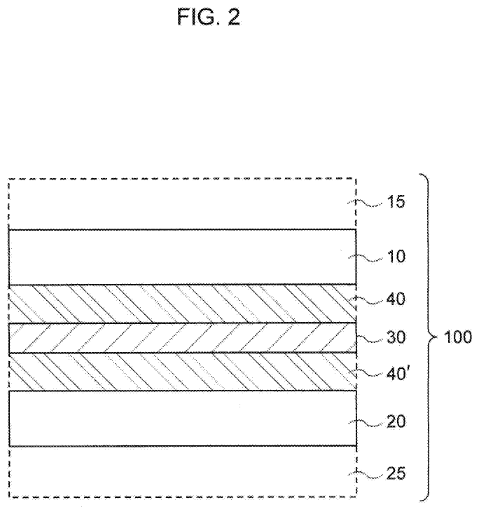

In another embodiment, the multilayer laminate comprises additional layers of other optical materials. One exemplary embodiment is illustrated in FIG. 2. Additional optional layers, can be positioned (as shown in FIG. 2) within the laminate between layer 10 and layer 30, as indicated by element 40, and/or between layer 20 and layer 30, as indicated by element 40′. The multilayer laminate may additionally include only element 40, only element 40′, or both elements 40 and 40′.

Each of elements 40 and 40′, if included, may comprise one or more layers of polymeric materials, and each layer is comprised of polymers different from polyvinyl alcohol. When both elements 40 and 40′ are included in laminate 100, they may be identical or different from each other. For example, one element may comprise a multilayer polymeric structure, and the other may comprise a single layer; in another embodiment, one element may comprise a layer comprised of a first polymeric material that is not polyvinyl alcohol, and the other element comprises one or more layers of other polymers, each of which is not polyvinyl alcohol.

In various embodiments, each of elements 40 and/or 40′ further comprise one or more additives or components mentioned previously with respect to layers 10, 20 and 30. The same or different additives and components may be included in each of elements 40 and 40′, or different amounts of additives and components may be included in each of elements 40 and 40′. Either or both elements 40 and 40′ may be included in embodiments of the multilayer laminate.

When element 40 or 40′ comprises multiple layers, each of the layers is different from polyvinyl alcohol. When element 40 (or alternatively, element 40′) comprises multiple layers, two or more of those layers may be identical to each other; in another embodiment, two or more layers of element 40 or element 40′ may have the same polymer structure, but may comprise different additives or components, as discussed above.

In one embodiment, element 40 and/or element 40′ contribute additional support to the multilayer laminate 100. In one such embodiment, the multilayer laminate 100 further comprises element 40 and element 40 comprises a single additional support layer; in another embodiment, the multilayer laminate 100 further comprises element 40′ and element 40′ comprises a single additional support layer; in another embodiment, the multilayer laminate comprises both element 40 and 40′, and the added elements 40 and 40′ each comprise a support layer. In one embodiment, element 40 and/or element 40′ comprise a polymeric layer that is stiffer and/or thicker than one or more of layers 10, 20 and/or 30.

In one embodiment, additional element 40 (but not additional element 40′) is included in the multilayer laminate 100, and element 40 comprises a single layer comprising polymeric material selected from cellulose triacetate, cellulose acetate butyrate, polyurethane, poly(urea-urethane), poly(methyl)methacrylate, polyacrylates, polycarbonate, optical-grade nylon polymers, polyesters and polystyrenes. In another embodiment, additional element 40′ (but not additional element 40) is included in the multilayer laminate 100, and element 40′ comprises a single layer comprising polymeric material selected from cellulose triacetate, cellulose acetate butyrate, polyurethane, poly(urea-urethane), poly(methyl)methacrylate, polyacrylates, polycarbonate, optical-grade nylon polymers, polyesters and polystyrenes. In another embodiment, both additional elements 40 and 40′ are included in the multilayer laminate 100, and each of elements 40 and 40′ comprises a single layer comprising polymeric material selected from cellulose triacetate, cellulose acetate butyrate, polyurethane, poly(urea-urethane), poly(methyl)methacrylate, polyacrylates, polycarbonate, optical-grade nylon polymers, polyesters and polystyrenes.

In other embodiments, either or both elements 40 and 40′ (if include in laminate 100) may comprise optional treatments to change the surface properties of the respective element. As mentioned previously, such treatments can act as moisture barriers, or can improve anti-fogging. Other optional treatments can increase resistant to impact or chemicals; or enhance adhesion of subsequent coatings, layers, or materials. In one embodiment, optional element 40 is treated to enhance adhesion to either or both layers 10 and 30. In another embodiment, optional element 40′ is treated to enhance adhesion to either or both layers 20 and 30.

Elements 40 and 40′ may contribute additional features or enhance optical, physical or chemical performance to laminate 100, due to their different polymeric materials, or the additives, components and/or treatments comprised in one or more of their polymeric layers. Elements 40 and 40′ may contribute different or similar features or enhance performance. In addition, the combination of each of elements 40 and 40′ with laminate 100 may provide synergistic effects that improve the optical, physical or chemical performance of the laminate.

In one embodiment, multilayer laminate 100 does not include (is free of) polarizer components. In one embodiment, none of layers 10, 20, or 30; optional elements 40 or 40′; or optional elements 15 or 25 (comprising one or more coatings and/or optional treatments) comprises a polarizer component.

In another embodiment, element 40 and/or element 40′ can comprise a polarizer component, which can be embodied as a film, wafer, supported film, coating, multilayer thin film coatings, multilayer polymeric film stack, wire grid, or an applied or embedded structure. In some embodiments, polarizers are selected from linear, gradient linear, elliptical, circular or variable polarizers, and can comprise solid, mixed, multiple or gradient tints.

Element 40 and/or 40′ may also comprise adhesives for improved bonding between the adjacent polyvinyl alcohol layers and this added optional element.

In another embodiment, the photochromic multilayer laminate 100, as described herein and in the exemplary schematics of FIGS. 1 and 2, is further incorporated into an eyewear lens. The laminate provides an effective new method to enable a photochromic eyewear lens. Use of the laminate incorporated into, with or onto an eyewear lens is particularly advantageous to maintain fast responsiveness of the photochromic materials, in addition to good adhesion and/or compatibility of photochromic media with optical lens materials. Surprisingly, the inventors found that laminate 100, even though it comprises polyvinyl alcohol layers that are usually considered delicate and highly heat sensitive, has good resistance to moisture damage, can be thermoformed, and can be combined successfully with normal lens manufacturing processes. The unique laminate design described herein enables more accurate, reproducible positioning of the photochromic layer within the lens, eases required post-processing of the lenses (such as surfacing and polishing) and therefore reduces breakage and product loss.

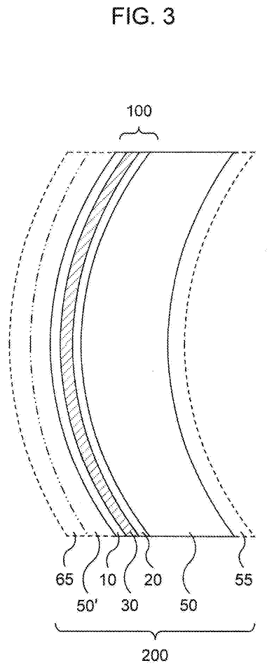

FIG. 3 provides an exemplary illustration of an eyewear lens comprising a photochromic multilayer laminate. For convenience and simpler drawing, a multilayer laminate 100 with only layers 10, 20 and 30 is shown in FIG. 3. This comprises the simplest form of laminate 100, but as discussed in the specification and illustrated in FIGS. 1 and 2, additional layers, elements and/or coatings are within the scope of the disclosure and the multilayer structure of laminate 100, and may comprise the laminate 100 incorporated in, with or onto eyewear lens 200.

FIG. 3 shows an eyewear lens 200 in an exemplary curved lens shape, as one might find for some common eyewear lenses, such as semi-finished ophthalmic lens blanks for spectacles. In FIG. 3, the surfaces (or interfaces) to the left show a simple convex curvature, and the surfaces (or interfaces) to the right show a simple concave curvature. In typical ophthalmic eyewear lenses, such as those used for spectacles for example, the convex curvature of the eyewear lens would be positioned away from the eye (farthest) from the eye, and the concave surface (to the right of FIG. 3) identifies the surface nearest the eye when worn. For ease of discussion, this orientation of the eyewear lens, with the side nearest the eye being the right side of FIG. 3, shall be used.

As an illustration of one embodiment, laminate 100 is also curved in FIG. 3. In other embodiments, the laminate may be flat and planar, or curved into shapes that are spherical, aspherical, toroidal, asymmetrical, variable, progressive, multifocal, or combinations of any of these. In other embodiments, laminate 100 may be shaped or bent such that one or both of its outer surfaces comprise stepped, discontinuous or offset surfaces or sections of surfaces.

The photochromic multilayer laminate may comprise these or other curved shapes either by itself, upon further processing in preparation for its use with various eyewear lenses, or upon its incorporation into the eyewear lens. Curving or shaping the multilayer laminate may be helpful or desirable for positioning the laminate accurately and/or securely within the eyewear lens. This can, for example, reduce potential damage to the laminate during further lens processing, such as surfacing. Curving or shaping of the laminate may also be helpful to increase adhesion and reduce strain or buckling between the laminate and the other elements of the eyewear lens 200. Various shapes may be used to complement or accommodate different types of eyewear lenses, different shapes of eyewear lenses, lens production processes, cosmetic factors or other design considerations.

Referring again to FIG. 3, layer 50 and optional layer 50′ comprise optical material(s) that further comprise the eyewear lens. The eyewear lens may comprise optical material(s) positioned on, bonded, or joined to only one side of the laminate 100 as indicated by layer 50, or optical material(s) positioned on, bonded, or joined to each side of the laminate 100, as indicated by layers 50 and 50′. In some instances, the eyewear lens may not require a layer of optical material (layer 50′) on the surface of the laminate 100 farthest from the eye when in use (i.e., to the left in FIG. 3); therefore, layer 50′ is indicated as an option for some embodiments, and identified by broken lines with a dot-dot-dash pattern. In other embodiments, the eyewear lens 200 comprises both layers 50 and 50′.

The photochromic multilayer laminate 100 comprises two opposite, outer surfaces of the total combination of layers and elements that comprise the laminate structure. In embodiments of the laminate without either elements 15 or 25, the outer surfaces will correspond to the second surface of layer 10 and the second surface of layer 20. In embodiments that further comprise element 15 but not element 25, the outer surfaces of the laminate will correspond to the outer surface of element 15 (i.e., the surface of element 15 that is farthest from layer 10) and the second surface of layer 20. Similarly, in embodiments that further comprise element 25 but not element 15, the outer surfaces of the laminate will correspond to the outer surface of element 25 (i.e., the surface of element 25 that is farthest from layer 20) and the second surface of layer 10. In embodiments of the laminate 100 that comprise both elements 15 and 25, the outer surfaces of the laminate will correspond to the outer surface of element 15 (i.e., the surface of element 15 that is farthest from layer 10) and the outer surface of element 25 (i.e., the surface of element 25 that is farthest from layer 20).

For convenience of description, the outer surface of the laminate that corresponds to second surface of layer 10 (or if the laminate comprises element 15, to the outer surface of element 15) shall be designated the first outer surface of the laminate, and the outer surface of the laminate that corresponds to second surface of layer 20 (or if the laminate comprises element 25, to the outer surface of element 25) shall be designated the second outer surface of the laminate.

In one embodiment, the photochromics multilayer laminate is positioned for incorporation into the eyewear lens 200 such that when the eyewear lens is in use (i.e., when the eyewear lens is worn before the eye), the laminate's first outer surface is positioned farther from the eye than the second outer surface of the laminate. In such embodiments, the first outer surface of the laminate corresponds to the second surface of layer 10 (or if the laminate comprises element 15, to the outer surface of element 15). In addition, in such embodiments, the laminate's other surface, that is, its second outer surface, corresponds to the second surface of layer 20 (or if the laminate comprises element 25, to the outer surface of element 25), and the laminate's second outer surface will be positioned nearer the eye when the eyewear lens is in use (i.e., when the eyewear lens is worn before the eye) than the first outer surface of the laminate.

Thus, in one embodiment of the eyewear lens 200 comprising laminate 100, the first outer surface of the laminate is farther from the eye when the eyewear lens is worn before the eye than the second outer surface of the laminate. This type of positioning of the laminate in the eyewear lens is illustrated by the exemplary drawing in FIG. 3.

In one embodiment, layer 50 is bonded to the second outer surface of the laminate. In one embodiment, layer 50′ is bonded to the first outer surface of the laminate. In one embodiment, layer 50 is positioned on the second outer surface of the laminate. In one embodiment, layer 50′ is positioned on the first outer surface of the laminate. In some embodiments of the eyewear lens, the second outer surface of the laminate is nearer the eye when the lens is worn (as described above and depicted with reference to FIG. 3) than the first outer surface of the laminate; in other embodiments of the eyewear lens, the first outer surface of the laminate is positioned nearer to the eye when the eyewear lens is worn than the second outer surface of the laminate.

The optical materials of layers 50 and/or 50′ support or provide important performance characteristics of the eyewear lens, such as physical strength, optical power, and optical, physical and chemical stability. In some embodiments, laminate 100 by itself will not have sufficient structural stability or all the necessary optical power or other eyewear lens properties to be used alone within an eyewear frame; therefore, it is combined with other elements (including layer 50 and optionally, layer 50′ to form an eyewear lens 200 with additional strength, stability and additional optical, physical or chemical properties to meet the demands of eyewear lenses. These layers may comprise polymeric layers, but extremely thin glass (sometimes called micro-glass) may also be used for one or more of the layers. Layers 50 and 50′ may also comprise mixed organic and inorganic materials of crystalline, amorphous or polymeric structures, and may each contain other additives or components (as mentioned previously) to modify their optical, physical or chemical properties.

For ophthalmic lens use, and particularly for eyewear lens products, these layers should exhibit low scatter and haze such that clear images may be seen when objects are viewed through them. In some embodiments, layers 50 and/or 50′ are transparent, but may transmit significantly less than 100% of visible light due to optical filtering properties. In one embodiment, the eyewear lens comprises layer 50, and layer 50 has a visible light luminous transmittance value of greater than 75% as measured and calculated in accordance with the American National Standards Institute (ANSI) Z80.3-2018 Standard for Ophthalmics-Nonprescription Sunglass and Fashion Eyewear Requirements (illuminant C reference). In one embodiment, the eyewear lens comprises both layers 50 and 50′, and at least one of layers 50 and 50′ has a visible light luminous transmittance of greater than 75% as measured and calculated in accordance with the American National Standards Institute (ANSI) Z80.3-2018 Standard for Ophthalmics-Nonprescription Sunglass and Fashion Eyewear Requirements (illuminant C reference). In another embodiment, both layers 50 and 50′ have visible light luminous transmittance values of greater than 75% as measured and calculated in accordance with the American National Standards Institute (ANSI) Z80.3-2018 Standard for Ophthalmics-Nonprescription Sunglass and Fashion Eyewear Requirements (illuminant C reference).

Exemplary optical materials for use in either or each of layers 50 and/or 50′ comprise organic polymer systems such as polyurea-urethanes, polyurethanes, polythiourethanes, thermoplastic polycarbonates, hard resin thermoset plastics [based on polyol(allyl carbonate) polymerization, and particularly on reactions of diethylene glycol bis(allyl carbonate)], polyacrylates, polymethacrylates, episulfides, other sulfur-containing polymers with refractive indices higher than about 1.56, polystyrenes, polyamides, optical-grade nylon polymers, acrylics, polyesters, polyurethane acrylates, polyurethane methacrylates, and other optical polymers. Layers 50 and/or 50′ may each comprise one or more combinations, mixtures or co-polymerizations of these or other optical materials. Layers 50 and/or 50′ may comprise the same optical material(s), different optical material(s), or differing combinations of optical materials. Layers 50 and/or 50′ and the optical materials comprising layers 50 and/or 50′ may each further comprise one or more additives or components, such as those additives or components discussed previously with respect to the laminate layers. Layers 50 and/or 50′ may each comprise optical material(s) with the same or different additives, or different concentrations of additives. Layers 50 and/or 50′ may each comprise optical material(s) with the same or different components, or different numbers of components.

In one embodiment, layers 50 and/or 50′ each comprise one or more organic polymer systems selected from polyurea-urethanes, polyurethanes, polythiourethanes, episulfides, and sulfur-containing polymers with refractive indices higher than about 1.56.

In one embodiment, layer 50 comprises additives selected from the group of UV absorbers, UV reflectors, UV stabilizers, visible light stabilizers, thermal stabilizers, antioxidants, optical brighteners, surfactants, plasticizers, polymer chain extenders, inert impact modifiers, IR reflectors and color additives. In one embodiment, at least one of layers 50 and 50′ comprise additives selected from the group of UV absorbers, UV reflectors, UV stabilizers, visible light stabilizers, thermal stabilizers, antioxidants, optical brighteners, surfactants, plasticizers, polymer chain extenders, inert impact modifiers, and IR reflectors.

In one embodiment, layer 50 comprises at least one or more coloring additive. In one embodiment, at least one of layers 50 and 50′ comprises one or more coloring additive.

Layers 50 and 50′ may each be uniform or non-uniform in thickness. Layers 50 and/or 50′ may each be plano, or one or both layers may contribute optical power to the eyewear lens due to their thickness and curvatures. Layers 50 and 50′ may each have curvatures that are spherical, aspherical, toroidal, asymmetrical, variable, progressive, multifocal, or combinations of any of these. Layers 50 and 50′ may each comprise stepped, discontinuous or offset optical sections on their surfaces.

Layers 50 and 50′ may have the same or different thicknesses. For eyewear lenses, typical finished lens thicknesses range from about 0.5 mm to about 2-10 mm, depending on such factors as required prescription strength, impact resistance, structural integrity, or other performance or aesthetic considerations. Semi-finished lens blanks that require additional grinding, edging, surfacing, and polishing to create prescription optical power lenses have lens thicknesses in the range of about 1 mm to 30 mm. Layer 50, or in embodiments with both layers, layers 50 and 50′ in combination may comprise the majority of these lens thicknesses. In embodiments of eyewear lens 200, layer 50 has a thickness of: less than 30 mm, less than 25 mm, less than 20 mm, less than 15 mm, less than 12 mm, less than 10 mm, less than 8 mm, less than 5 mm, less than 3 mm, less than 2 mm, less than 1 mm or less than 0.5 mm but greater than about 50 μm.

Elements 55 and 65 are optional elements comprising coatings that may comprise the eyewear lens 200. Either or both elements 55 and 65 may be included in the eyewear lens. As indicated in FIG. 3, in some embodiments, element 65 may be adjacent to or positioned on layer 50′; and in other embodiments, element 65 may be adjacent to or positioned on the first outer surface of the photochromic multilayer laminate 100. In some embodiments, element 55 may be adjacent to or positioned on layer 50; in one embodiment, element 55 is bonded to layer 50. In some embodiments, element 65 may be bonded to layer 50′, and in other embodiments, element 65 may be bonded to the first outer surface of the photochromic multilayer laminate 100.

Coatings that may comprise optional element(s) 55 and/or 65 for the eyewear lens 200 include hard coatings, hydrophobic coatings, anti-fog coatings, moisture-barrier coatings, mirror coatings, visible light anti-reflective coatings, UV anti-reflective coatings, thermochromic coatings, electrochromic coatings, photochromic coatings, polarizing coatings, polarizing multilayer thin film coatings, multilayer interference coatings, conductive coatings, infrared light-filtering coatings, visible light-filtering coatings and UV light-filtering coatings and other coatings to tailor the optical, chemical or mechanical properties of the lens. These coatings may be uniform or create gradients across the coated surface; gradient effects may be particularly desirable with electrochromic coatings, photochromic coatings, polarizing coatings, polarizing multilayer thin film coatings, multilayer interference coatings, conductive coatings, visible light-filtering coatings and UV light-filtering coatings. If polarizing coatings are included, they may comprise single layer coatings, supported film coatings, multilayer thin film coatings, multilayer polymeric film stacks, wire grids, or include an applied or embedded structure. In some embodiments, polarizing coatings are selected from linear, gradient linear, elliptical, circular or variable polarizers, and can comprise solid, mixed, multiple or gradient tints. These coatings may comprise one or more layers. For instance, multilayer interference coatings of dielectric, metal/dielectric or conductive/insulating materials can range from two to several hundreds of layers. In addition, one or more types of coatings may be used in combination to form either element 55 or 65. In exemplary embodiments of the eyewear lens 200 comprising both elements 55 and 65, the one or more coatings comprising elements 55 and 65 may be similar, identical or different from each other.

In one embodiment, elements 55 and 65 each comprise one or more coatings selected from the group of hard coatings, hydrophobic coatings, anti-fog coatings, moisture-barrier coatings, mirror coatings, visible light anti-reflective coatings, UV anti-reflective coatings, infrared light-filtering coatings, visible light-filtering coatings and UV light-filtering coatings. In one embodiment, neither element 55 nor 65 comprise photochromic coatings, polarizing coatings, or polarizing multilayer thin film coatings.

Either or both of elements 55 and 65 may comprise optional treatments to change the surface properties of the lens 200, and include such options as moisture barriers, anti-fogging and ease of cleaning treatments.

The eyewear lens 200 can further comprise components (as mentioned previously) that enhance appearance, or modify the performance or functionality of the product for particular eyewear lens use. These components can be included in or on the multilayer laminate 100; elements 50, 50′, 55 or 65; or the components can be separate elements of the lens.

The multilayer laminate 100, which may comprise layers and elements as illustrated in FIGS. 1 and 2 and as further described in this specification, can be positioned at or close to the outer surface of the eyewear lens 200, at or close to the inner surface of eyewear lens 200, or intermediate within the structure of the eyewear lens 200. In one embodiment, as shown in FIG. 3, multilayer laminate 100 is positioned toward the outer surface of eyewear lens 200 when it is in use (worn before the eye). This may allow better exposure of the photochromic material(s) in laminate 100 to activating sunlight.

In one embodiment, the multilayer laminate 100 is positioned toward the outer surface of eyewear lens 200 when it is in use (worn before the eye), but the eyewear lens further comprises optical material element 50′ that is positioned even further from the eye than laminate 100. In another embodiment, the multilayer laminate 100 is positioned toward the outer surface of eyewear lens 200 when it is in use (worn before the eye), but the eyewear lens further comprises optional coating element 65 that is positioned even further from the eye than laminate 100; in one embodiment, the multilayer laminate 100 is positioned toward the outer surface of eyewear lens 200 when it is in use (worn before the eye), but the eyewear lens further comprises both optical material element 50′ and optional coating element 65 that are positioned sequentially even further from the eye than laminate 100. These additional elements may comprise optical material(s), coating(s), additives, and/or components that protect, enhance or designedly modify the performance of the photochromic multilayer laminate within the eyewear lens.

In some embodiments, photochromic multilayer laminate 100 is positioned near the outer surface of eyewear lens 200. In one embodiment, laminate 100 of the eyewear lens is positioned within 1 mm of the outermost surface of lens 200; in another embodiment, within 0.2-0.7 mm of the outermost surface. If the eyewear lens is configured to position laminate 100 near the outer surface of lens 200, and lens 200 further comprises layer 50′ and/or element 65, then layer 50′ (or the combination of layer 50′ and element 65) in one embodiment is less than or equal to about 1 mm thick; in another embodiment, between about 0.1 μm-0.7 mm thick; and in another embodiment, between about 0.2-0.7 mm thick.

In one embodiment, multilayer laminate 100 does not include (is free of) polarizer components in any of its layers or elements and is free of polarizing coatings. In another embodiment, eyewear lens 200 does not include (is free of) any polarizer components or polarizing coatings.

In one embodiment, the eyewear lens 200 has a visible light luminous transmittance in the faded state of greater than 75% as measured and calculated in accordance with the American National Standards Institute (ANSI) Z80.3-2018 Standard for Ophthalmics-Nonprescription Sunglass and Fashion Eyewear Requirements (illuminant C reference). In one embodiment, the eyewear lens 200 has a visible light luminous transmittance in the exposed state of greater than 8% as measured and calculated in accordance with the American National Standards Institute (ANSI) Z80.3-2018 Standard for Ophthalmics-Nonprescription Sunglass and Fashion Eyewear Requirements (illuminant C reference).

Layer 50 and/or layer 50′ can be combined with multilayer laminate 100 and other optional elements of the eyewear lens by various methods of optical lens molding, casting, or reaction methods known in the art. These include methods for optical lens and lens blank manufacturing suitable for thermosetting materials, thermoforming materials, reaction-injection molding, and modifications of such techniques for use with laminates, inserts or films. Lamination and fusion techniques may also be used. Additional exemplary techniques include sequential filling techniques and the sidefill technique with a suspended or supported laminate similar to methods described in U.S. Pat. Nos. 7,002,744 B2 and 7,582,235 B2. Other examples of lens manufacturing techniques include joining or adhesively bonding the laminate to an existing lens blank, or joining the laminate to a lens blank and then applying a thin layer of liquid-phase optical material to the outer surface of the laminate. Several of these lens manufacturing methods can be employed to create layers 50 and 50′ that are either identical or similar optical materials, or distinctly different optical materials (e.g., different polymer chemistries). Other methods of production or combination of laminate 100 and the layers, coatings and elements of the eyewear lens 200 are known in the art or described herein.

The moisture content of the photochromic layer 30 and/or the laminate may be adjusted (typically reduced) for improved compatibility with lens manufacturing processes. Adjustment of the moisture content, which also affects the moisture stability for layer 30, is particularly advantageous. As moisture content of the photochromic layer 30 is reduced, less damage occurs to the laminate and/or lens during subsequent exposure to moisture, high humidity, or elevated temperature and humidity. Reduction of moisture content is balanced with possible embrittlement, wrinkling or deformation of the materials due to excessive drying. As one example, extended exposure of layer 30 to temperatures in excess of 150° C. before incorporation into the laminate could be expected to cause damage. Nonetheless, moisture content may be beneficially adjusted to different degrees for different lens manufacturing processes. The gentle drying to increase the moisture stability of this layer 30 is also beneficial for limiting the layer's moisture content, thus reducing both its individual moisture sensitivity and improving its compatibility and performance in subsequent optical articles. For example, some lens materials (such as, for example, polyurea-urethanes, episulfides, and polythiourethanes), are more prone to undesired and less controlled side reactions (such as, for example, haze, bubbles or loss of adhesion) in the presence of excess moisture. Therefore, with these lens materials, more reduction or control of the moisture content of layer 30 and/or laminate 100 is required than with some other lens monomers or polymers.

Significant advantages of various embodiments of the laminate and optical articles incorporating it described herein include eyewear lenses comprising laminate 100 showing excellent photochromic performance with very fast fade-back rates and good adhesion, even after processing the lens blank into finished spectacle lenses.

Additional significant photochromic performance advantages result in the laminate and optical articles incorporating it as described herein. Significantly improved fade-back speed results for the multilayer laminate alone or incorporated into an eyewear lens, as compared to photochromic polyurea-urethane lenses made with the same photochromic materials incorporated directly into a commercially available A-side reactant (TRIVEX® A reactant composition, PPG Industries, Inc., Pittsburgh, Pa.) used to form lens-quality polyurea-urethane materials.

Surprisingly, the depth of coloration was not significantly compromised by the fast responsiveness of the multilayer laminate, even within an eyewear lens. This is a surprising and highly advantageous result, because normally as speed of response increases, the laminate and resultant lens may not get as dark (i.e., the range in transmittance values from non-activated or “at rest” lenses to fully activated lenses is reduced). One can understand this trade-off in properties due to the ease of rotation or reconfiguration of the photochromic molecule; if it is free to rotate and change configuration, the speed of response increases. However, that freedom of movement typically also means it is not held in its new position, can easily revert and may not achieve as dense a color.

The design and structure of layer 30, laminate 100 and the laminate's incorporation into a lens showed much better performance than predicted from this trade-off hypothesis. This is illustrated in the following non-limiting examples.

### EXAMPLES

Preparation of Exemplary Photochromic Layer 30.

Preparation of polyvinyl alcohol solution. 20% by weight polyvinyl alcohol pellets (MOWIOL® 4-88, molecular weight˜31000, a trademarked product of Kuraray Europe GmbH, available from Sigma-Aldrich, Inc.) were added to deionized water in a beaker equipped with a magnetic stir rod on a hot plate. The mixture was stirred at 250 rpm and maintained at 100° C. for 4 hours to form an aqueous solution that was 20% by weight polyvinyl alcohol. The 20% solution was transferred into a commercially available (McMaster-Carr Supply Co.) stainless steel tank and pressurized with dry air at 15 psi. The tank was placed in an oven at 100° for 48 hours to ensure complete dissolution of the polyvinyl alcohol in the deionized water.

Preparation of photochromic dye solution. Proprietary naphthopyran photochromic materials (Tokuyama Corp., Tokyo, Japan) were combined with a mixture made of 60% by weight M812 (Miglyol 812, Cremer Oleo Division/Warner Graham Co., Cockeysville, Md.) and 40% by weight 1-bromonaphthalene (available from Sigma-Aldrich, Inc.) to form an oil/solvent solution containing 8% by weight of the combined photochromic materials. Mixtures of two or more photochromic materials were combined to achieve a more neutral, greyish color upon activation. All the ingredients were placed in a beaker at room temperature, then heated on a hot plate at 80° C. with magnetic stirring at 300 rpm for 30 minutes until the photochromic materials were dissolved in the solution.

Preparation of nanodroplet emulsion. The polyvinyl alcohol solution and the photochromic dye solution were combined at a weight ratio of 90:10, and stirred at 300 rpm at room temperature for 20 minutes to form a pre-emulsion liquid preparation. The pre-emulsion liquid preparation was then introduced into a high-pressure homogenizer (LM20 Microfluidizer High Shear Fluid Processor, Microfluidics Corp. Westwood, Mass.) at a flow rate of 65 g/min. The LM20 system was operated at 30,000 psi and is equipped with a heat exchanger coil in a water bath that was set to maintain the system's temperature at 30-40° C. The pre-emulsion liquid preparation was cycled 20 times through the LM20 system in order to obtain the desired nanodroplet size within the emulsion. After 20 passes, the nanodroplet size was measured using a laser diffraction particle size analyzer (LA-960, Horiba Scientific, Horiba Ltd., Japan) and found to average about 100 nm with a standard deviation of about 27 nm.

The nanodroplet emulsion was then poured as a thin layer into 100 mm diameter polystyrene petri dishes. Uncovered petri dishes containing the nanodroplet emulsion were placed in a clean airflow lab bench, and allowed to dry at room temperature for 40 hours. After this drying, the resultant exemplary photochromic layer 30 was removed from petri dish. Various examples of photochromic layer 30 were prepared by this method and their photochromic performance properties are summarized in Table 1. The exemplary photochromic layers prepared by this method showed very low visible light haze (˜0.5-0.3), as measured on a HAZE-GARD haze meter (BYK Gardner USA, Columbia, Md.) and showed uniform coloration as observed by eye upon sunlight exposure.

Preparation of exemplary multilayer laminate 100. Clear non-plasticized, optical grade polyvinyl alcohol roll-cast sheeting, 80 micrometers thick, was obtained (item VF-PS, Kuraray, Japan), cut into squares approximately 7 inches by 7 inches (17.8 cm by 17.8 cm) and used as layers 10 and 20 for the exemplary laminate 100. One surface of each sheet was dampened by lightly wiping with a low-lint paper towel wetted with deionized water. A photochromic layer 30 formed from the nanodroplet emulsion described above was placed on the wet surface of one of the sheets, and the second sheet was placed on top of layer 30 with its wet surface in contact with layer 30. This stack of polyvinyl alcohol layers was fed into a laminator (Hot Roll Laminator, model HL-100, ChemInstruments, Inc. Fairfield, Ohio) with a nip opening of 0.10 mm; the rollers were run at 75 in/min (1.9 m/min, control dial at 4) and maintained at a temperature of 60° F. (16° C.).

Laminates prepared by this method are identified in Table 1. The resultant laminate 100 samples made by this method showed good adhesion and did not delaminate with either normal handling or with hand prying at the edges. These laminate 100 samples had good clarity and color uniformity, as judged by visual inspection in the unactivated state and when exposed to sunlight, and low haze (less than 2.5). Additional laminates made by these methods were incorporated into exemplary eyewear lenses as described below. These exemplary laminates were measured and/or used in flat form for these specific Examples.

Formation of eyewear lens incorporating the multilayer laminate. 0.05B semi-finished lens blanks incorporating exemplary laminates were prepared with layers 50 and 50′ made of TRILOGY™ polyurea-urethane optical lens material (Younger Mfg. Co., Torrance, Calif.). For ease of reference in these examples, layer 50 comprises added TRILOGY optical material that would be positioned closer to the eye than the laminate of the exemplary lens when worn, and layer 50′ comprises added TRILOGY optical material that would be further from the eye than the laminate (in this instance, the outer or front surface).

The TRILOGY optical material of layers 50 and 50′ is formed from commercially available TRIVEX® A-side and B-side reactants (PPG Industries, Inc., Pittsburgh, Pa.). A commercial reactive processing machine (Max Machinery, Healdsburg, Calif.) was used to hold the A-side and B-side reactants at controlled temperatures, and then mix and dispense them at controlled temperatures and flow rates to provide a B:A equivalent weight ratio of 0.83:1.0 for these exemplary lenses.

A modified sequential filling technique was used to form layers 50 and 50′ for the semi-finished lens blanks of these Examples. To prepare layer 50, mold assemblies were formed of a 0.50D spherical convex glass back mold and a 0.50D spherical glass concave front mold with an exemplary laminate 100 resting directly on the concave front mold surface. These mold assemblies were pre-heated to 60° C. for 10 minutes and then the controlled mix of A-side and B-side reactants was dispensed into the mold assemblies. The pre-heated mold assemblies were allowed to rest seven minutes to partially cure layer 50 in preparation for the next lens manufacturing step. After the resting period, the 0.50D spherical concave front mold was lifted off the mold assembly, exposing the laminate's outer surface. The controlled mix of additional A and B reactants was dispensed for 3 seconds onto this outer surface of the laminate, an 0.50D spherical glass concave mold placed carefully over the dispensed material, and the new assembly clamped to hold the molding surfaces in position against the dispensed reactant materials. The new assembly was placed in an oven and the complete lens construct cured at 128° C. for 6 hours to yield 76 mm diameter lens blanks. These exemplary lens blanks were quite thick (approximately 12.5 mm), to illustrate that even such massive blanks had good haze values (less than 2.5) and good visual clarity. These eyewear lens blanks, even with the multiple layers, had sufficient adhesion to complete the demanding steps of processing into a finished ophthalmic lens successfully, without edge damage or delamination. The lenses were visually observed to darken and lighten uniformly in response to sunlight exposure and shading of the lenses, respectively.

Comparative photochromic lens examples. Comparative examples C1 and C2 were prepared by an additive lens forming method similar to that described in the Examples of US Application 2018/0251675 A1. A 6B clear TRILOGY semi-finished single vision polyurea-urethane lens blank, ˜8 mm thick, was used as the back molding surface and was spaced with a gasket approximately 0.7 mm from a spherical glass concave 6B front mold to create the mold assembly for the added photochromic layer of these comparative examples. TRIVEX A-side reactant, commercially available from PPG Industries, Inc., was modified by adding photochromic dye solutions (prepared as described herein above) to constitute 1.5% by weight of the TRIVEX A-side reactant composition. In addition, approximately 0.75-1% by weight of a commercially available (Axel Plastics Research Laboratories, Inc., Woodside, N.Y.) internal mold release agent was added to the A-side mixture to prevent adhesion of the exothermically reacting material to glass molding surfaces. This modified A-side reactant and TRIVEX B-side reactant were mixed and dispensed via the reactive injection processing machine (Max Machinery) into the pre-heated (10 minutes at 60° C.) mold assembly. The assembly was allowed to cure in an oven at 128° C. for 6 hours to form a new front surface layer of photochromic polyurea-urethane, securely adhered to the original 6B clear TRILOGY semi-finished single vision polyurea-urethane lens blank.

Both exemplary and comparative lenses were surfaced on standard commercial ophthalmic lens edging, surfacing and polishing equipment. The lenses were edged to about 70 mm round diameters before surfacing. All lenses were back-side surfaced to produce finished lenses of plano power, with lens thicknesses as indicated in Table 1.

Comparative photochromic dye solutions. Photochromic dye solutions were made as discussed herein above, except the combined photochromic materials constituted only 1% by weight of the 60%:40% oil/solvent mixture.

Photochromic measurements on the optical articles. In preparation for photochromic performance measurements, the exemplary and comparative semi-finished eyewear lens blanks were each surfaced to plano power with total lens thicknesses as indicated in Table 1. Exemplary photochromic layers (30) and laminates (100) were measured in flat form for photochromic performance as reported in Table 1. The comparative photochromic dye solutions were placed in spectrometer cuvettes with an optical path length of 10 mm for photochromic measurements.

The photochromic performance measurements were obtained using a BPC300 Photochromic Lens Characterisation System (Bentham Instruments Ltd, Reading, Berkshire, U.K.). The activation source is a Xenon lamp that approximates solar irradiance with an air mass 1.5 filter. Samples were held at 23° C. and irradiated for 3 minutes while the visible spectrum was recorded. Then the solar activation source was blocked, and the spectral response during fade-back was recorded over 10 minutes.

From this data, luminous transmittance for the sample was measured and calculated in accordance with the American National Standards Institute (ANSI) Z80.3-2018 Standard for Ophthalmics-Nonprescription Sunglass and Fashion Eyewear Requirements (illuminant C reference) for the sample at rest [that is, unexposed to light that would activate the sample's photochromic material(s)] and for the sample in the darkest state with its photochromic material(s) activated. In addition, the darkening rate and fade-back rate were monitored by observing and recording each lens sample's percent transmittance at 555 nm throughout the 3-minute activation period and the 10-minute fade-back period.

The range of photochromic response was determined by noting the initial light transmittance (rest transmittance) at 555 nm and the darkest (lowest) transmittance recorded during activation. The time it took for the eyewear lens to reach the transmittance value at half of this range was reported as t_{1/2}D (time to reach half the ultimate darkness of the lens). Once the activating source was blocked, t_{1/2}F (time to fade back from half the ultimate darkness of the lens) was then reported as the time it took for the lens to recover to this same % T value as recorded during the darkening cycle.

Photochromic performance is summarized in Table 1 below for these examples, as well as for comparative photochromic lens samples (C1 and C2), and for comparative liquid oil/solvent solutions of the A and B mixtures of photochromic materials (S1 and S2).

TABLE 1

| | | Photochromic | | | | Luminous | | |
|---|---|---|---|---|---|---|---|---|
| | | mix, % by | Thickness | Thickness | Thickness | T (%, | | |
| | | weight in | (μm) of | (μm) of | (mm) of | darkest | | |
| | Photochromic | indicated | layer | layers | 200 or | state, | t_{1/2}D | t_{1/2}F |
| Ex. | mix | element | 30 | 10 & 20 | liquid cell | Illum. C) | (s) | (s) |
| 1 | A | 2.8% in 30 | 220 | N/A | N/A | 14.82 | 3 | 23 |
| 2 | A | 2.8% in 30 | 130 | N/A | N/A | 20.21 | 4 | 24 |
| 3 | B | 2.8% in 30 | 190 | N/A | N/A | 7.11 | 2 | 32 |
| 4 | A | 2.8% in 30 | 240 | 80 | N/A | 13.22 | 3 | 22 |
| 5 | A | 2.8% in 30 | 160 | 80 | N/A | 16.56 | 3 | 21 |
| 6 | A | 2.8% in 30 | 220 | 80 | 4.5 | 13.75 | 4 | 24 |
| 7 | A | 2.8% in 30 | 230 | 80 | 4.5 | 13.83 | 4 | 24 |
| 8 | A | 2.8% in 30 | 240 | 80 | 4.5 | 13.09 | 3 | 23 |
| C1 | A | 1.5% in FS | N/A | N/A | 2 | 14.86 | 10 | 104 |
| | | A-side | | | | | | |
| C2 | B | 1.5% in FS | N/A | N/A | 2 | 9.83 | 8 | 115 |
| | | A-side | | | | | | |
| S1 | A | 1% in oil | — | N/A | 10 mm | 14.39 | 3 | 24 |
| | | sol'n | | | cell | | | |
| S2 | B | 1% in oil | — | N/A | 10 mm | 7.46 | 3 | 33 |
| | | sol'n | | | cell | | | |

Notes for Table 1
A = photochromic mixture of 62% of a naphthopyran compound that exhibits blue color upon UV activation; 33% of a naphthopyran compound that exhibits orange color upon UV activation and 5% of a naphthopyran compound that exhibits yellow color upon UV activation
B = photochromic mixture of 70% of a naphthopyran compound that exhibits blue color upon UV activation and 30% of a naphthopyran compound that exhibits gray color upon UV activation
FS A-side = photochromic materials added to A-side reactant composition used to form added front surface layer.

Examples S1 and S2 provide a comparison with conditions that should allow maximum speed and darkening; the photochromic molecules have almost no physical constraints to rotation or reconfiguration in this solution. The photochromic performance in these solutions, particularly the fade-back rates, is excellent.

Advantageously, the exemplary photochromic layers of Examples 1 and 3 show very similar photochromic performance to the good attributes of their respective photochromic materials in solution (S1 and S2, respectively). Example 2 does not darken as much as either S1 or Example 1, but this may be due to its thinner cross-section; there may not be sufficient photochromic concentration in this thinner layer for full absorption of light within the layer.

Likewise, the laminate of Example 4 shows excellent photochromic performance comparable to S1. Again, the thinner laminate of Example 5 shows excellent darkening speed and fade-back rate, but may be too thin to give the lowest transmittance values.

Examples 6-8 illustrate that excellent photochromic performance is maintained when the laminate is incorporated into an eyewear lens. In comparison, Examples C1 and C2 still show good photochromic performance, but they are demonstrably slower in response than the solutions, or than these exemplary embodiments (Examples 6-8).

Interestingly, the data shows that excellent photochromic performance can be achieved and maintained not only for photochromic layer 30 alone, but also upon its combination within the laminate 100 and upon incorporation of the laminate into an eyewear lens 200.

These non-limiting examples illustrate that one can significantly improve fade-back rates while maintaining or improving the darkness of a fully exposed lens with embodiments of the multilayer photochromic laminate.

While the specification has described in detail certain exemplary embodiments, and multiple variations or derivatives of these embodiments, one skilled in the art will appreciate that additional substitutions, combinations, and modifications are possible without departing from the concept and scope of the disclosure. These and similar variations would become clear to one of ordinary skill in the art after inspection of the specification and the drawings herein.

1. A photochromic multilayer laminate 100 comprising:
(a) a first solid layer 10 comprised of polyvinyl alcohol, with a first surface and a second surface on the opposite side of the layer from the first surface;
(b) a second solid layer 20 comprised of polyvinyl alcohol, with a first surface and a second surface on the opposite side of the layer from the first surface; and
(c) a third layer 30 comprised of polyvinyl alcohol and one or more photochromic materials,
wherein the third layer is positioned between the first surface of the first layer and the first surface of the second layer of the laminate.

2. The photochromic multilayer laminate of claim 1, wherein the third layer is directly bonded to the first surface of the first layer and the first surface of the second layer.

3. The photochromic multilayer laminate of claim 2, wherein the third layer 30 acts as an adhesive layer between layer 10 and layer 20.

4. The photochromic multilayer laminate of claim 1, said laminate being free of polarizer components and polarizing coatings.

5. The photochromic multilayer laminate of claim 1, wherein at least one of the first layer 10 and the second layer 20 further comprise at least one or more additives selected from the group of electrochromics, thermochromics, non-photochromic nanoparticles, liquid crystals, dyes, tinting agents, pigments, mold release agents, UV absorbers, UV reflectors, UV stabilizers, visible light stabilizers, thermal stabilizers, antioxidants, optical brighteners, surfactants, plasticizers, polymer chain extenders, inert impact modifiers, IR reflectors, visible light filters, color blockers, selective light reflectors, and selective light absorbers.

6. The photochromic multilayer laminate of claim 1, wherein the third layer 30 further comprises one or more additives selected from the group including UV absorbers, UV reflectors, dyes, pigments, tinting agents, color blockers, selective visible light absorbers, thermal stabilizers and UV stabilizers.

7. The photochromic multilayer laminate of claim 1, further comprising at least one of:
(d) an additional element 15 positioned on the second surface of the first layer 10, and
(e) an additional element 25 positioned on the second surface of the second layer 20,
wherein each of additional elements 15 and 25 comprise one or more coatings selected from hard coatings, primer coatings, hydrophobic coatings, anti-fog coatings, moisture-barrier coatings, impact-resistant coatings, chemically-resistant coatings, mirror coatings, visible light anti-reflective coatings, UV anti-reflective coatings, electrochromic coatings, thermochromic coatings, photochromic coatings, polarizing coatings, polarizing multilayer thin film coatings, multilayer interference coatings, conductive coatings, visible light-filtering coatings, UV light-filtering coatings and infrared light-filtering coatings.

8. The photochromic multilayer laminate of claim 1, further comprising at least one of:
(f) an additional element 40 positioned between the first surface of first layer 10 and third layer 30, and
(g) an additional element 40′ positioned between the first surface of second layer 20 and third layer 30,
wherein layer 40 and layer 40′ each comprise one or more polymers, said polymers being free of polyvinyl alcohol.

9. The photochromic multilayer laminate of claim 1, wherein the one or more photochromic materials comprised in third layer 30 are each selected form the group including: silver halides, dichroic metal oxides, dichroic organic dyes, thermochromics, spiro(indoline)pyrans, naphthopyrans, benzopyrans, dithizonates, benzoxazines, spiro-oxazines, spiro(indoline)naphthoxazines, spiro-pyridobenzoxazines, anthroquinones, oxazines, indolizines, fulgides, and fulgimides.

10. The photochromic multilayer laminate of claim 9, wherein the form of at least one of the photochromic materials comprising layer 30 is selected from the group including: nanodroplets, photochromic nanoparticles and encapsulated forms having a capsule size in the range of 20 nm to 500 nm.

11. The photochromic multilayer laminate of claim 1, wherein the third layer 30 comprising at least two photochromic materials, and wherein at least one of the photochromic materials is activated by at least visible light.

12. A photochromic eyewear lens 200 comprising the photochromic multilayer laminate 100 of claim 1, and further comprising:
an additional layer 50 with a first surface and a second surface on the opposite side of the layer from the first surface,
wherein the laminate 100 has a first outer surface and a second outer surface;
wherein the first surface of layer 50 is positioned on the second outer surface of laminate 100, and
wherein layer 50 is comprised of one or more optical materials selected from the group including: thermoplastic polycarbonate, hard resin thermoset polymers, poly(urea-urethanes), polythiourethanes, episulfides, other sulfur-containing polymers with refractive indices higher than about 1.56, polystyrenes, polyamides, optical-grade nylon polymers, acrylics, polyacrylates, and polymethacrylates.

13. The photochromic eyewear lens 200 of claim 12, wherein when the lens is worn in front of the eye, layer 50 is nearer the eye than laminate 100.

14. The photochromic eyewear lens 200 of claim 12, further comprising
an additional layer 50′ with a first surface and a second surface on the opposite side of the layer from the first surface,
wherein the first surface of layer 50′ is positioned on the first outer surface of laminate 100, and
wherein layer 50′ is comprised of one or more optical materials selected from the group including: thermoplastic polycarbonate, hard resin thermoset polymers, polyurea-urethanes, polythiourethanes, episulfides, other sulfur-containing polymers with refractive indices higher than about 1.56, polystyrenes, polyamides, optical-grade nylon polymers, acrylics, polyacrylates, and polymethacrylates.

15. The photochromic eyewear lens 200 of claim 14, further comprising at least one of:
an additional element 55 positioned on the second surface of layer 50, and
an additional element 65 positioned on the second surface of layer 50′,
wherein each of elements 55 and 65 comprise one or more coatings selected from hard coatings, primer coatings, hydrophobic coatings, anti-fog coatings, moisture-barrier coatings, impact-resistant coatings, chemically-resistant coatings, mirror coatings, visible light anti-reflective coatings, UV anti-reflective coatings, electrochromic coatings, thermochromic coatings, photochromic coatings, polarizing coatings, polarizing multilayer thin film coatings, multilayer interference coatings, conductive coatings, visible light-filtering coatings, UV light-filtering coatings and infrared light-filtering coatings.

16. The photochromic eyewear lens 200 of claim 14, wherein each of layers 50 and 50′ further comprise at least one or more additives selected from the group including: UV absorbers, UV reflectors, UV stabilizers, visible light stabilizers, thermal stabilizers, antioxidants, optical brighteners, surfactants, plasticizers, polymer chain extenders, inert impact modifiers, IR reflectors and coloring additives.

17. The photochromic eyewear lens 200 of claim 12, further comprising one or more additives selected from the group including: mold release agents, thermal stabilizers, light stabilizers, UV absorbers, UV reflectors, antioxidants, chain extenders, optical brighteners, surfactants, plasticizers, polymer chain extenders, inert impact modifiers, UV stabilizers, visible light stabilizers, thermal stabilizers, antioxidants, optical brighteners, IR reflectors, and coloring additives.

18. The photochromic eyewear lens 200 of claim 12, further comprising:
an additional element 55 bonded to the second surface of layer 50, wherein element 55 comprises one or more coatings selected from the group including: hard coatings, hydrophobic coatings, anti-fog coatings, moisture-barrier coatings, mirror coatings, visible light anti-reflective coatings, ultraviolet light anti-reflective coatings, electrochromic coatings, thermochromic coatings, photochromic coatings, polarizing coatings, polarizing multilayer thin film coatings, multilayer interference coatings, conductive coatings, visible light-filtering coatings, ultraviolet light-filtering coatings and infrared light-filtering coatings.

19. The photochromic eyewear lens 200 of claim 12, said lens being free of polarizer components and polarizing coatings.

20. The photochromic eyewear lens 200 of claim 14, said lens being free of polarizer components and polarizing coatings.
